(19) United States
(12) Patent Application Publication
(10) Pub. No.: US 2007/0048072 A1
(43) Pub. Date: Mar. 1, 2007

(54) Ring binder mechanism

(75) Inventors: Chun Yuen To, Hong Kong (CN); Hung Yu Cheng, Hong Kong (CN); Chun Cheung Law, Hong Kong (CN)

Correspondence Address: SENNIGER POWERS, ONE METROPOLITAN SQUARE, 16TH FLOOR, ST LOUIS, MO, 63102, US

(73) Assignee: World Wide Stationery Mfg. Co., Ltd., Hong Kong (CN)

(21) Appl. No.: 11/363,921

(22) Filed: Feb. 28, 2006

Related U.S. Application Data
(60) Provisional application No. 60/712,045, filed on Aug. 29, 2005.

(51) Int. Cl. B42F 3/00

(52) U.S. Cl. 402/60

(57) ABSTRACT

A ring mechanism for retaining loose-leaf pages includes a housing having a central top portion and an open bottom generally opposed to the central top portion. The central top portion has a longitudinally extending channel therein along the entire length of the housing. Hinge plates supported by the housing may pivot relative to the housing. The hinge plates support ring members that pivot with the hinge plates to open and close rings for adding and removing loose-leaf pages. In one version, the housing can be of a skeletonized construction, with the channel providing additional rigidity for the housing.

This application claims the benefit of U.S. Provisional Application No. 60/712,045, filed Aug. 29, 2005, the entire disclosure of which is hereby incorporated by reference.

### BACKGROUND OF THE INVENTION

This invention relates to a ring binder mechanism for retaining loose-leaf pages, and in particular to a ring binder mechanism that is sturdy, light weight and uses less material than conventional binder mechanisms.

As is known in the art, a typical ring binder mechanism retains loose-leaf pages, such as hole-punched pages, in a file or notebook. It has multiple rings each including two half ring members capable of selectively opening to add or remove pages, or selectively closing to retain pages and allow them to move along the ring members. The ring members mount on two adjacent hinge plates that join together about a pivot axis for pivoting movement within an elongated housing. The housing loosely holds the hinge plates so they may pivot relative to the housing. The undeformed housing is slightly narrower than the joined hinge plates when the hinge plates are in a coplanar position (180°). So as the hinge plates pivot through this position, they deform the resilient housing and cause a spring force in the housing urging the hinge plates to pivot away from the coplanar position, either opening or closing the ring members. Thus, when the ring members are closed, the spring force resists hinge plate movement and clamps the ring members together. Similarly, when the ring members are open, the spring force holds them apart. An operator may typically overcome this force by manually pulling the ring members apart or pushing them together. In addition, in some mechanisms the operator may move a lever located at one or both ends of the mechanism to move the hinge plates through the coplanar position.

Such conventional ring binder mechanisms use a relatively substantial amount of material, usually steel, and thus are relatively heavy in order to maintain their rigidity so as not to be permanently deformed during their use.

Accordingly, there is a need for a ring binder mechanism that uses less material than conventional ring binders and is yet rigid enough to operate over an extended period without permanent deformation such that it will become inoperable.

### SUMMARY OF THE INVENTION

A ring binder mechanism for retaining loose-leaf pages generally comprises a housing supporting hinge plates for pivoting motion relative to the housing. The mechanism also includes rings for holding the loose-leaf pages. Each ring includes a first ring member and a second ring member. The first ring member is mounted on a first hinge plate and is moveable with the pivoting motion of the first hinge plate relative to the second ring member. The two ring members move between a closed position and an open position. In the closed position, the two ring members form a substantially continuous, closed loop for allowing loose-leaf pages retained by the rings to be moved along the rings from one ring member to the other. In the open position, the two ring members form a discontinuous, open loop for adding or removing loose-leaf pages from the rings.

In one aspect, the ring binder mechanism housing has a longitudinal axis, a central top portion and an open bottom generally opposed to the central top portion. The central top portion has a longitudinally extending channel therein along the entire length of the housing. The channel has opposed ends and a middle portion. The channel can be of constant cross-section from one end to the other or may have different cross-sections along its length.

In another aspect, the ring binder mechanism may have a housing having a longitudinal axis, a central top portion and an open bottom generally opposed to the central top portion, and at least one rib on the housing disposed transversely to the longitudinal axis thereof. The housing may include a plurality of the ribs being spaced along the longitudinal axis of the housing.

In yet another aspect, the ring binder mechanism housing may have a plurality of openings defined therein for receiving a corresponding first or second ring member when the ring members are in the closed position, an area of the housing immediately surrounding each opening having a ridge formed therein.

In another aspect, the ring binder mechanism housing may have a longitudinal axis, a central top portion, an open bottom generally opposed to the central top portion, and opposed lateral edges extending along the length of the housing, the housing having a plurality of separate openings defined therein spaced along the length of the housing and extending into either of the opposed lateral edges. The hinge plates preferably have openings defined therein corresponding to and juxtaposed with the openings defined in the housing. Preferably, the openings in the hinge plates are such that they cannot be seen from directly above the housing which may be the result of the openings in the hinge plates being larger than corresponding openings in the housing.

Other features of the invention will be in part apparent and in part pointed out hereinafter.

### BRIEF DESCRIPTION OF THE DRAWINGS

FIG. 1 is a perspective of a notebook incorporating a conventional ring binder mechanism showing an environment in which the present invention may be utilized;

FIG. 2 is a perspective view of a first embodiment of the mechanism of the present invention;

FIG. 3 is an exploded perspective view of the embodiment of FIG. 1;

FIG. 4 is a bottom perspective of the mechanism of FIG. 1 at a closed and locked position;

FIG. 5 is a perspective similar to FIG. 2 with the mechanism at an open position;

FIG. 6 is a perspective similar to FIG. 4 with the mechanism at an open position;

FIG. 7 is a cross-sectional view in the direction of line 7-7 in FIG. 2;

FIG. 8A is a top plan view of a housing of a second embodiment in accordance with the present invention;

FIG. 8B is a perspective of the housing shown in FIG. 8A;

FIG. 8C is a cross-sectional view in the direction of line 8-8 in FIG. 8A;

FIG. 9 is a perspective view of a third embodiment of the mechanism of the present invention with the mechanism in a closed position;

FIG. 10 is a perspective similar to FIG. 9 with the mechanism in an open position;

FIG. 11 is a bottom perspective of the mechanism of FIG. 9 in a closed and locked position;

FIG. 12 is a perspective similar to FIG. 11 with the mechanism in an open position;

FIG. 13 is an exploded perspective view of the embodiment of FIG. 9;

FIG. 14A is a top plan view of a housing of a fourth embodiment in accordance with the present invention;

FIG. 14B is a perspective of the housing shown in FIG. 14A;

FIG. 14C is a cross-sectional view in the direction of line 14-14 in FIG. 14A;

FIG. 15 is a perspective view of a fifth embodiment of the mechanism of the present invention with the mechanism in a closed position;

FIG. 16 is a perspective similar to FIG. 15 with the mechanism in an open position;

FIG. 17 is a bottom perspective of the mechanism of FIG. 15 in a closed and locked position;

FIG. 18 is a perspective similar to FIG. 17 with the mechanism in an open position;

FIG. 19 is an exploded perspective view of the embodiment of FIG. 15;

FIG. 20A is a top plan view of a housing of a sixth embodiment in accordance with the present invention;

FIG. 20B is a perspective of the housing shown in FIG. 20A;

FIG. 20C is a cross-sectional view in the direction of line 20-20 in FIG. 20A;

FIG. 21 is a perspective view of a seventh embodiment of the mechanism of the present invention with the mechanism in a closed position;

FIG. 22 is a perspective similar to FIG. 21 with the mechanism in an open position;

FIG. 23 is a bottom perspective of the mechanism of FIG. 21 in a closed and locked position;

FIG. 24 is a perspective similar to FIG. 23 with the mechanism in an open position;

FIG. 25 is an exploded perspective view of the embodiment of FIG. 21;

FIG. 26A is a top plan view of a housing of an eighth embodiment in accordance with the present invention;

FIG. 26B is a perspective of the housing shown in FIG. 26A;

FIG. 26C is a cross-sectional view in the direction of line 26-26 in FIG. 26A;

FIG. 27A is a top plan view of a housing of a ninth embodiment in accordance with the present invention;

FIG. 27B is a perspective of the housing shown in FIG. 27A;

FIG. 27C is a cross-sectional view in the direction of line 27C-27C in FIG. 27A;

FIG. 27D is a cross-sectional view in the direction of line 27D-27D in FIG. 27A;

FIG. 28A is a top plan view of a housing of a tenth embodiment in accordance with the present invention;

FIG. 28B is a perspective of the housing shown in FIG. 28A;

FIG. 28C is a cross-sectional view in the direction of line 28C-28C in FIG. 28A;

FIG. 28D is a cross-sectional view in the direction of line 28D-28D in FIG. 28A;

FIG. 29A is a top plan view of a housing of an eleventh embodiment in accordance with the present invention;

FIG. 29B is a perspective of the housing shown in FIG. 29A;

FIG. 29C is a cross-sectional view in the direction of line 29-29 in FIG. 29A;

FIG. 30 is a cross-sectional view of the eleventh embodiment in accordance with the present invention showing the ring members in an open position;

FIG. 31 is a perspective view of a twelfth embodiment of the mechanism of the present invention with the mechanism in a closed position;

FIG. 32 is a perspective similar to FIG. 31 with the mechanism in an open position;

FIG. 33 is a bottom perspective of the mechanism of FIG. 31 in a closed and locked position;

FIG. 34 is a perspective similar to FIG. 33 with the mechanism in an open position;

FIG. 35 is an exploded perspective view of the embodiment of FIG. 31;

FIG. 36A is a top plan view of a housing of the twelfth embodiment;

FIG. 36B is a perspective of the housing shown in FIG. 36A;

FIG. 36C is a cross-sectional view in the direction of line 36C-36C in FIG. 36A;

FIG. 36D is a cross-sectional view in the direction of line 36D-36D in FIG. 36A;

FIG. 37 is a cross-sectional view in the direction of line 37-37 in FIG. 31;

FIG. 38 is a top plan view of a thirteenth embodiment of the present invention;

FIG. 39 is a perspective of the embodiment shown in FIG. 38;

FIG. 40A is a top plan view of a housing of a fourteenth embodiment of the present invention;

FIG. 40B is a perspective view of the housing shown in FIG. 40A; and

FIG. 40C is a cross-sectional view in the direction of line 40-40 in FIG. 40A.

Corresponding reference characters indicate corresponding parts throughout the views of the drawings.

### DETAILED DESCRIPTION OF THE INVENTION

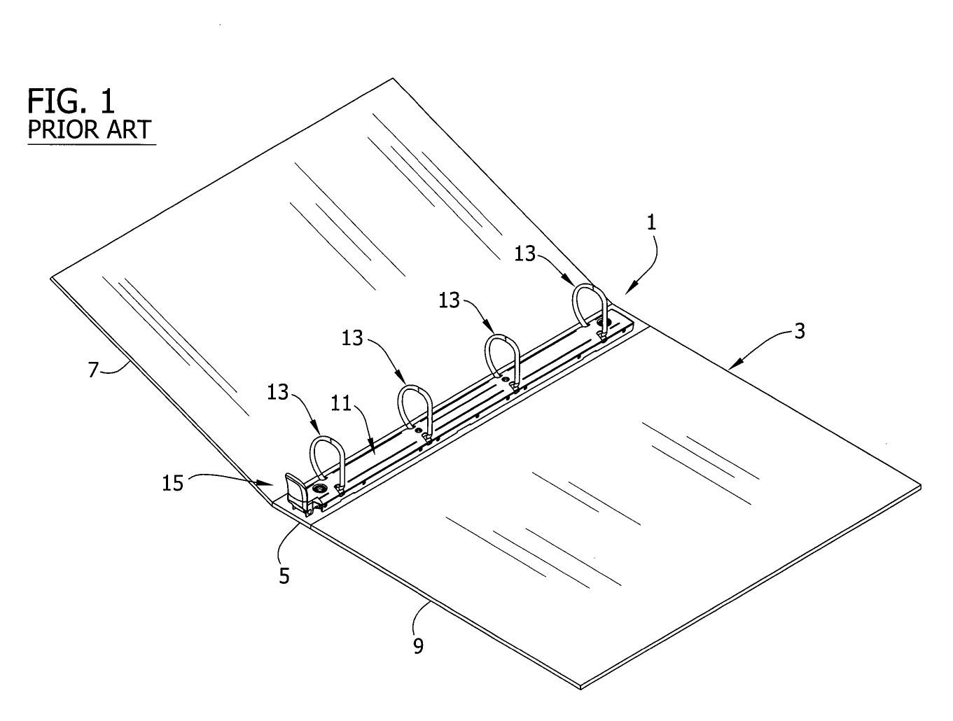

Referring now to the drawings, FIG. 1 shows an exemplary prior art ring binder, generally indicated by reference numeral 1, in a notebook 3 in which the embodiments of the present invention may be utilized. The mechanism is capable of retaining loose-leaf pages (not shown) in the notebook. In particular, mechanism 1 is shown mounted on spine 5 of notebook 3 having front cover 7 and back cover 9 hingedly attached to the spine for moving to selectively cover or expose retained pages in a well known manner.

As can be seen, mechanism 1 includes a housing, designated generally by reference numeral 11, supporting three rings, each designated generally by reference numeral 13. Each ring includes two ring members that will be described more hereinafter. A lever (broadly, “actuator”), designated generally by reference numeral 15, is shown pivotally mounted on one longitudinal end of housing 11 and can move ring members of rings 13 between a closed position and an open position. Lever 15 is also moveable to lock the rings closed, as will be described in greater detail hereinafter. In illustrated mechanism 1, a second longitudinal end of housing 11 has no actuating lever. But it is to be understood that a mechanism having an actuating lever at both ends of a housing does not depart from the scope of the invention. Moreover, actuators other than levers (e.g., a push button) could be used within the scope of the invention. Further, a mechanism with a different number of rings, greater or fewer than three, does not depart from the scope of this invention. Still further, the ring mechanism of the invention may be used by itself with supporting structure other than a notebook.

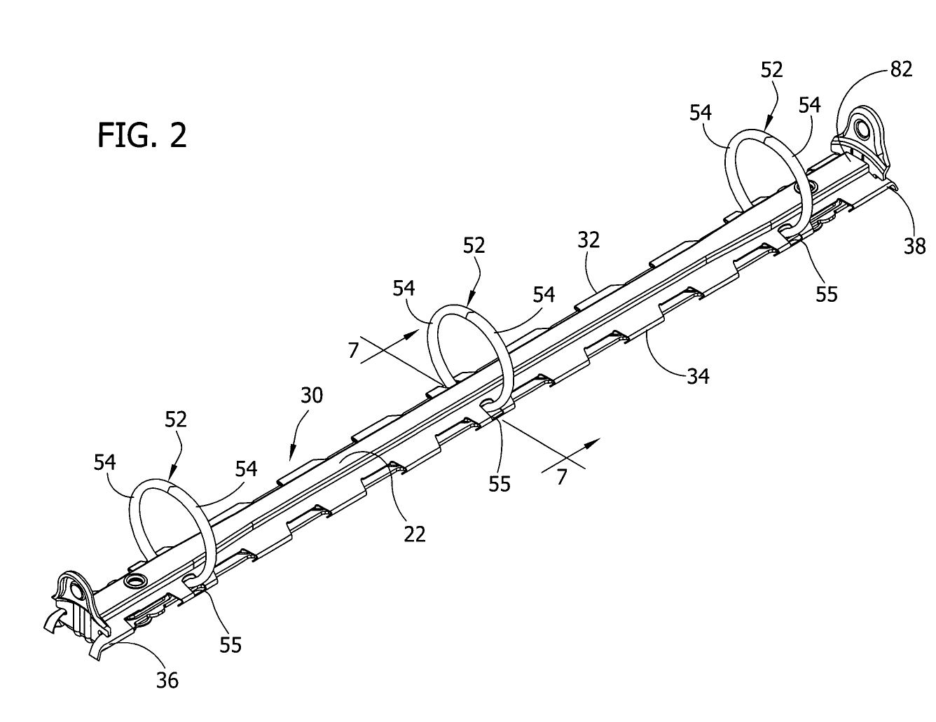

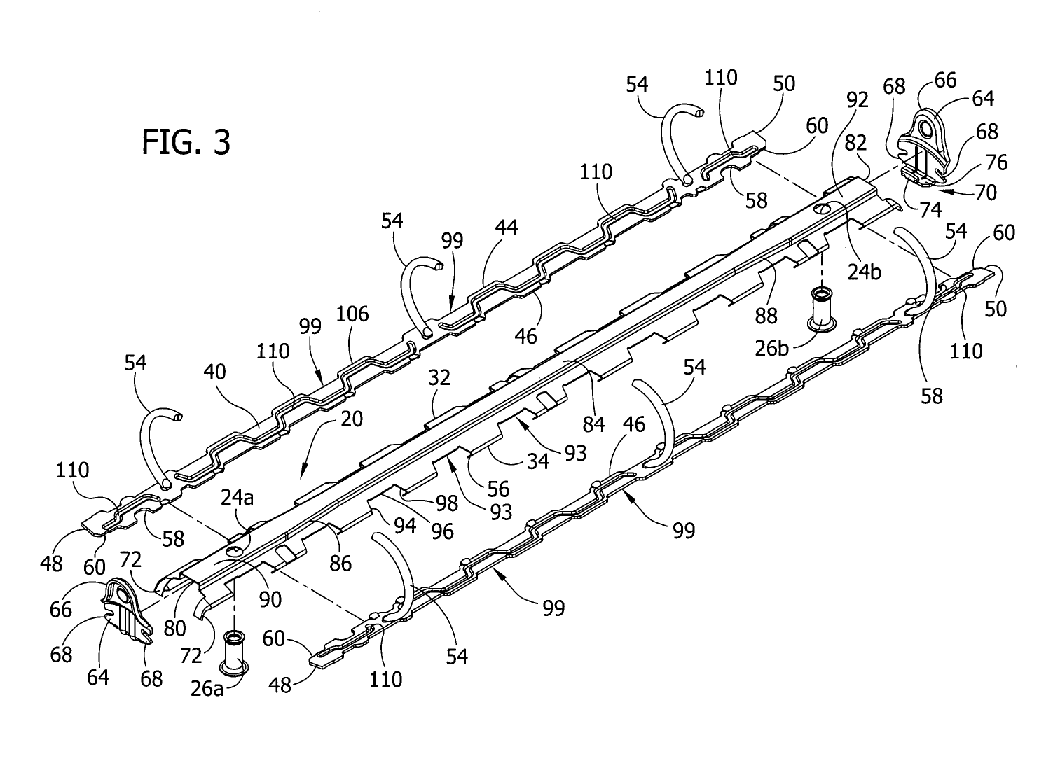

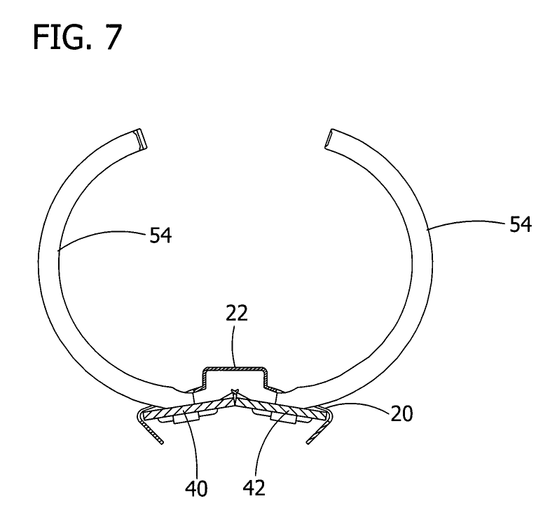

Now referring to FIGS. 2-7, which illustrate a first embodiment in accordance with the present invention, and with initial reference to FIGS. 2 and 3, a housing 20 is elongate and has a uniform, generally arch-shaped elevated cross section having channel 22 at its center. Two openings 24a and 24b are provided in the channel for receiving and attaching first and second mounting posts 26a and 26b to secure the mechanism, generally designated 30, to the spine 5 of a notebook 3 (FIG. 1). It will be appreciated that the ring mechanism 30 could be attached to either the front or back covers 7,9 or attached to another surface not associated with the notebook 3. The housing 20 also has a longitudinal axis, two generally opposite longitudinal edges 32 and 34, and two opposite ends 36 and 38.

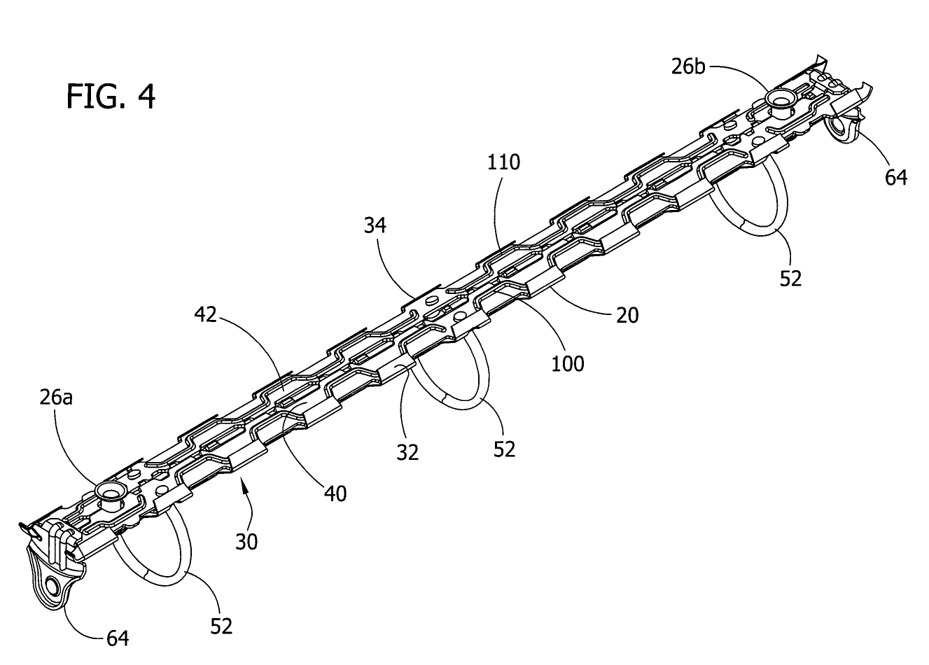

As shown in FIGS. 3 and 4, mechanism 30 includes two substantially similar hinge plates 40 and 42. Each hinge plate is a thin, elongate sheet having inner and outer longitudinal edge margins 44 and 46 and two opposed ends 48 and 50. Three rings 52, each composed of mating ring members 54 are secured to respective hinge plates 40 and 42.

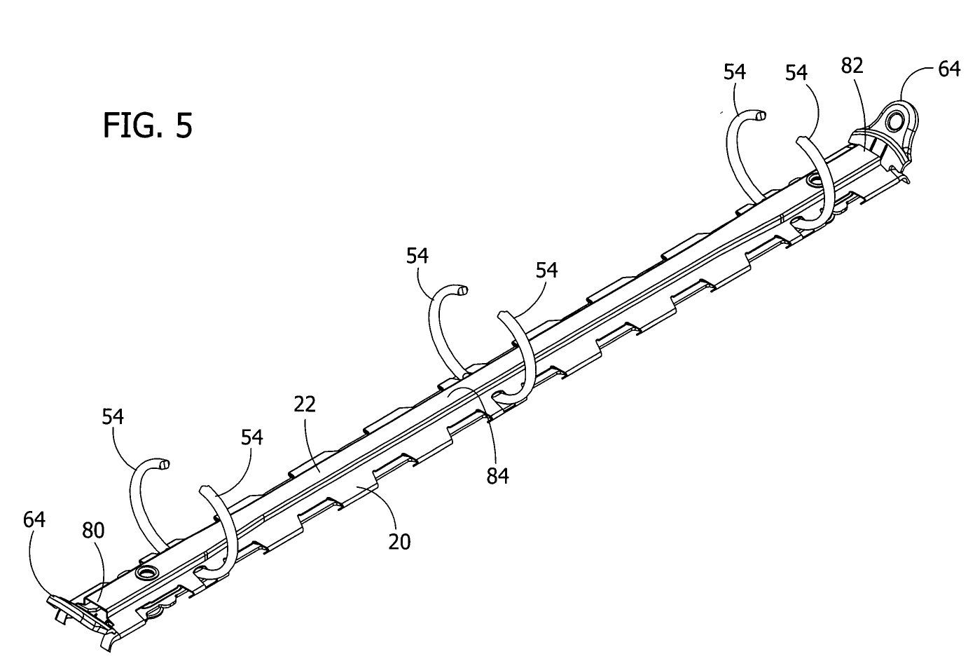

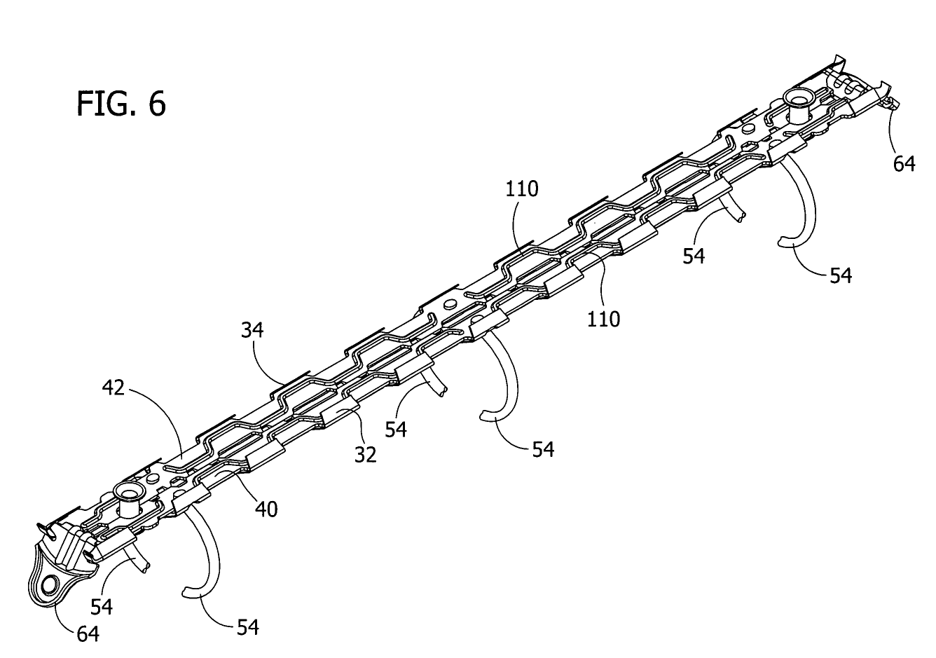

Ring members 54 of each ring 52 are generally circular in cross section and are mounted on upper surfaces of hinge plates 40 or 42 in longitudinally opposed relation. They are movable, passing through the openings 55 formed in housing 20, conjointly with hinge plates 40 and 42 during operation between a closed position (e.g., FIGS. 2 and 4) wherein each ring member forms a continuous, closed circular loop for retaining loose-leaf pages, and an open position (FIGS. 5 and 6) wherein each ring member forms a discontinuous, open loop suitable for adding or removing pages. Ring members having different cross sections or ring members that form different shapes when closed (e.g., a D-shape) do not depart from the scope of the invention. Although both ring members 54 of each ring 52 are movable in the illustrated embodiment, a mechanism in which one ring member is movable and one is fixed does not depart from the scope of this invention (e.g., a mechanism in which one ring member of each ring is mounted on a hinge plate and one is mounted on a housing).

As is known in the art, the hinge plates 40 and 42 interconnect in parallel arrangement along their adjoining inner longitudinal edge margins to form a central hinge having a pivot axis, which allows the two plates 40 and 42 to pivot relative to each other and move the respective ring members 54 of each ring 52 between the closed position and the open position. The connected plates 40 and 42 are generally received by the housing 20 such that each plate's outer longitudinal edge margin loosely fits above a bent rim portion 56 of housing 20. Accordingly, the hinge plates 40 and 42 are retained on the housing 20 but their outer edges are free to move within the rims 56, allowing the plates 40 and 42 to freely pivot about the pivot axis. The pivot axis moves up (i.e., toward the housing's upper surface) when the hinge plates 40 and 42 pivot to open the ring members 54, and it moves down (i.e., away from the housing's upper surface) when the plates 40 and 42 pivot to close the ring members 54.

A pair of rounded cutouts 58 are positioned along the inner longitudinal edge margin of each hinge plate 40 and 42, while squared notches 60 are similarly positioned along the inner edge margins at the ends of plates 40 and 42. When the hinge plates interconnect, corresponding cutouts 58 in the adjacent hinge plates 40 and 42 align and form two openings symmetrically positioned about the pivot axis of the plates. These openings receive the mounting posts 26a and 26b therethrough, and allow the hinge plates to pivot relative to the posts 26a and 26b without engaging them. The notches 60 similarly align and form box-shaped recesses at the opposite ends of the plates 40 and 42. Each recess receives a portion of a respective actuating lever 64 as will be described in greater detail hereinafter, and allows the levers to interact with the hinge plates 40 and 42 to open and close the ring members 54.

As shown in FIGS. 3 and 4, the two actuating levers 64 each includes a head 66 that extends upward from the lever above the housing 20 for allowing an operator to grasp and pivot the lever 64. Each lever 64 additionally includes two lateral arms 68 and a cam 70. The arms 68 extend laterally outward from opposite sides of each lever 64 and loosely fit within two pockets formed by tabs 72 located at the longitudinal ends of the housing 20 for pivoting within the pockets relative to the housing 20 about an axis transverse to the housing. The cam 70 of each lever is integrally attached to the lever below the lateral arms 68 and extends downward from the arms to fit into one of the respective box-shaped recesses (formed by notches 60) of the hinge plates 40 and 42. An enlarged tab 74 of each cam (the tab of only one cam is shown in FIGS. 3 and 4) generally fits loosely over the interconnected hinge plates 40 and 42 while a base 76 of each cam generally rests below the plates. Together, the tab 74 and base 76 releasably lock the hinge plates 40 and 42 therebetween for operable engagement to control the pivoting motion of the hinge plates that close and open the ring members 54. In operation (not shown), to close the ring members 54, the levers 64 are pivoted upward and inward. The tabs 74 of each lever engage a top surface of the hinge plates 40 and 42 and pull the pivot axis of the plates downward. To open the ring members 54, the levers 64 are pivoted outward and downward. The base 76 of each lever engages a bottom surface of the hinge plates and pushes the pivot axis of the plates upward.

In this mechanism 30, it is to be understood that the housing 20 is slightly narrower than the joined hinge plates 40 and 42 when the hinge plates are in a coplanar position (i.e., an angle between exterior surfaces of the hinge plates 40 and 42 is 180°). So as the hinge plates 40 and 42 pivot through this position, they deform the resilient housing 20 and cause a spring force in the housing that urges the hinge plates to pivot away from the coplanar position, either closing the ring members 54 (i.e., moving the pivot axis down and away from the housing's upper surface) or opening them (i.e., moving the pivot axis up and toward the housing's upper surface). Moreover, when the ring members 54 are closed, this spring force of the housing 20 resists hinge plate movement and clamps the ring members together. When the ring members 54 are open, the spring force holds them apart. It is to be understood that other mechanisms for obtaining relative movement of the ring members and holding them closed or open may be used without departing from the scope of the invention.

Referring particularly to FIGS. 2, 3 and 5, as previously mentioned, housing 20 has a channel 22 which in the case of this embodiment has a varying cross-section from end 80 to end 82. The central section 84 of channel 22 has a constant box-shaped cross-section which extends for approximately three-quarters of the length of housing 20 although the length of this central section can vary as desired for stiffening the housing 20 which is the purpose of this cross-sectional shape. At transitional sections 86 and 88 the channel has a constantly laterally expanding cross-section while keeping the same height, each transitional section joining an outer constant box-shaped cross-section end 90 and 92, respectively. The central section 84, transitional sections 86 and 88 and ends 90 and 92 can be varied in length and cross-section in order to obtain the desired stiffening of the housing 20, as desired.

In addition to the stiffening structure described above, a further aspect of this embodiment is the removal of substantial amounts of material from the housing by a series of generally trapezoidal cutouts 93 formed by side margins 94, 96 and 98 through the longitudinal edges 32 and 34 and rims 56 of housing 20. These cutouts 93 reduce the structural stiffness of the housing 20, but this is compensated for by the cross-sectional structure of channel 22 described above so that an adequate structural stiffness can be provided in housing 20 with reduced material usage from prior art devices.

Also in this embodiment, hinge plates 40 and 42 are provided with generally trapezoidal cutouts 99 formed by side margins 100, 102 and 104 in longitudinal edges 106 and 108 in each hinge plate. These trapezoidal cutouts 99 are preferably aligned with corresponding trapezoidal cutouts 99 in the housing 20 when the hinge plates are assembled in the housing, as shown in FIGS. 2 and 3. In addition, generally semi-cylindrical cross-section ridges 110 (or depressions depending on which side it is viewed from) are formed in the hinge plates 40 and 42 in a shape which follows the pattern formed by the cutouts 99 in the hinge plates to add additional stiffening to the hinge plates as a result of the removal of material to form the cutouts 99.

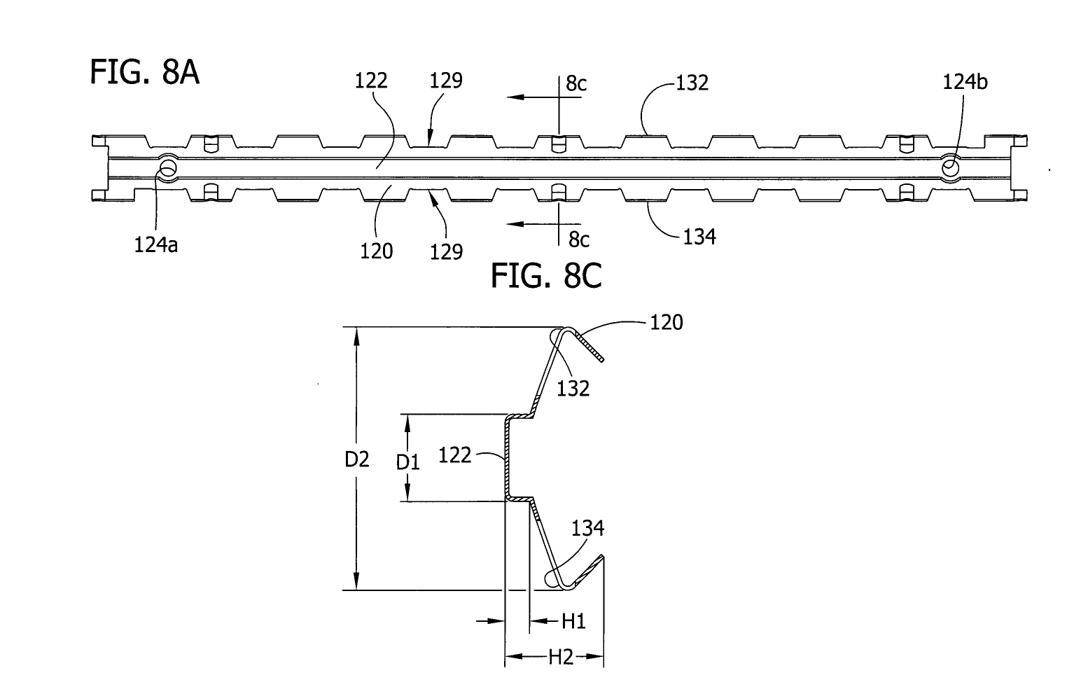

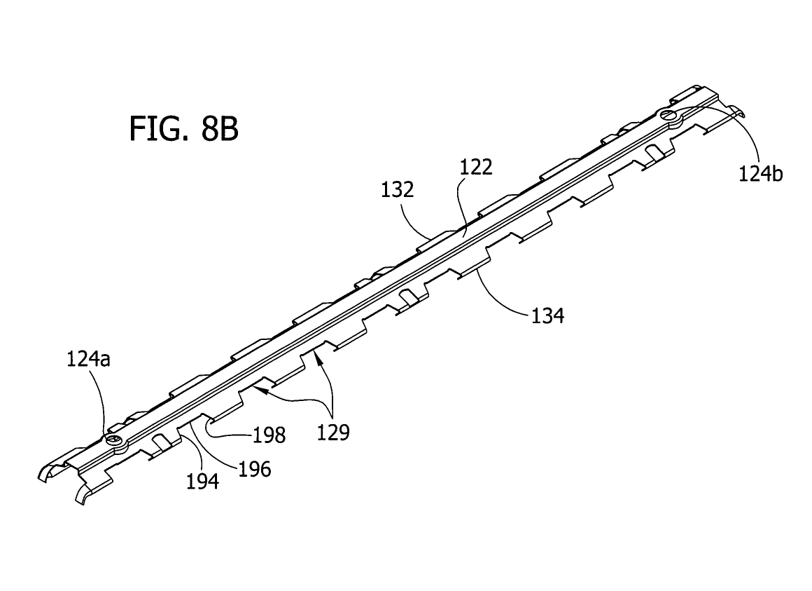

A housing 120 of a second embodiment of the present invention is illustrated in FIGS. 8A-8C in which the cross-section of channel 122, which is similar to channel 22 in the previous embodiment, is essentially constant except in the area of the openings 124a and 124b for receiving the mounting posts (not shown) where it is expanded in conformity with the openings. In this embodiment, the housing 120 also has trapezoidal cutouts 129 formed in its longitudinal edges 132 and 134 by side margins 194, 196 and 198. The hinge plates (not shown) can be shaped as in the first embodiment. As shown in FIG. 8C, the width D1 of channel 122 is approximately one-third the width D2 of housing 120 and the height H1 is approximately one-quarter the height H2 of housing 120. The first embodiment is similarly proportioned.

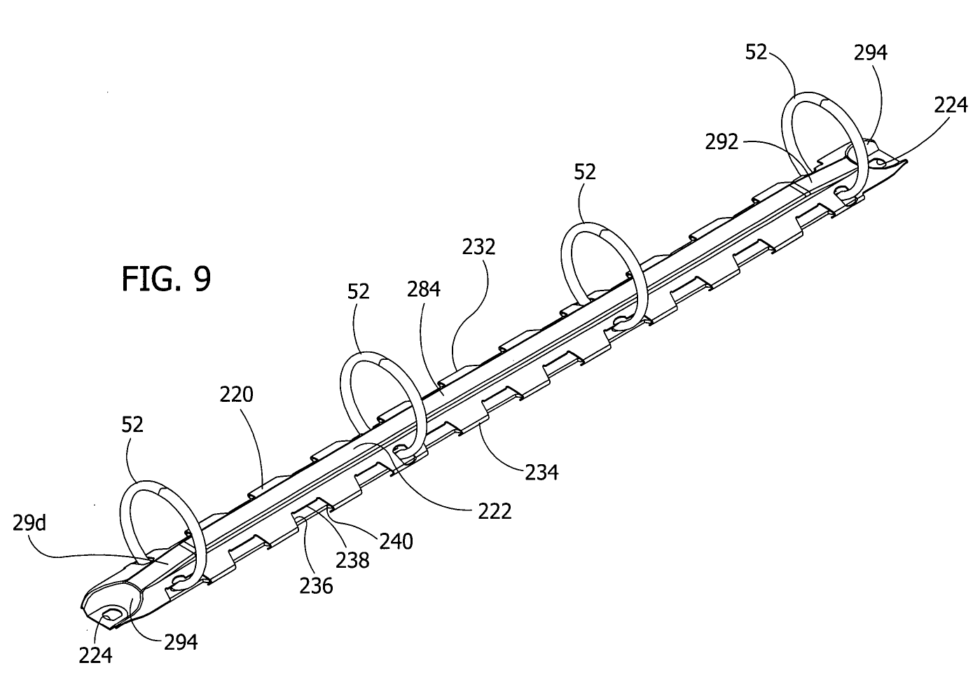

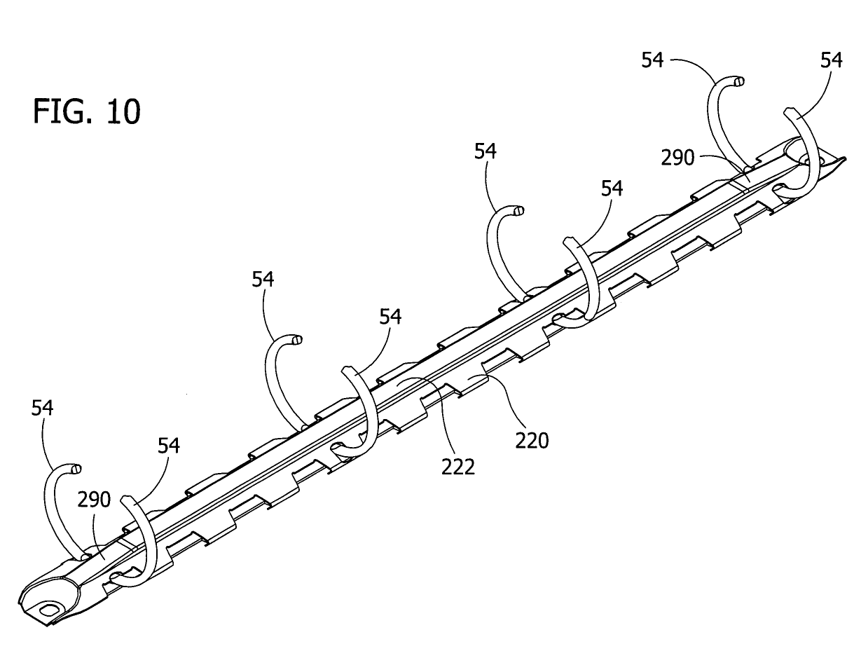

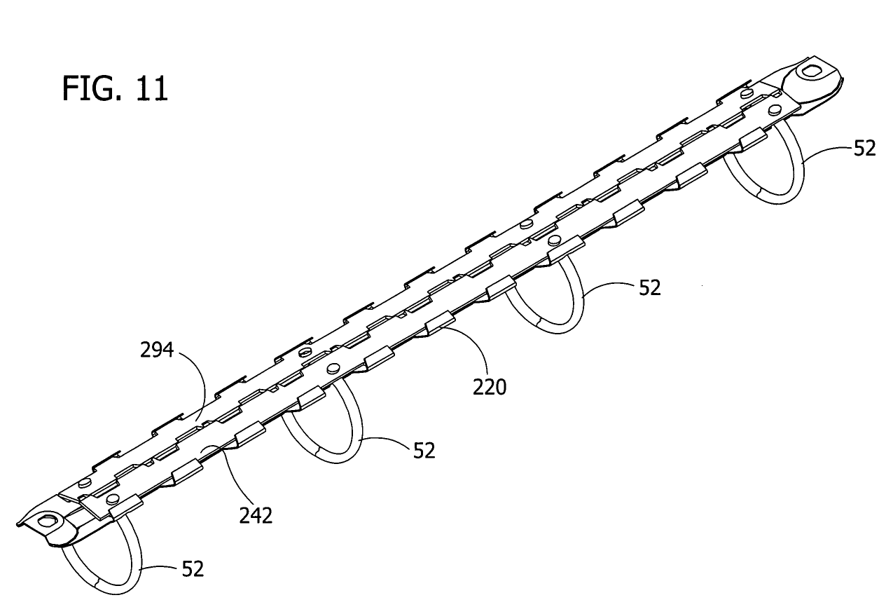

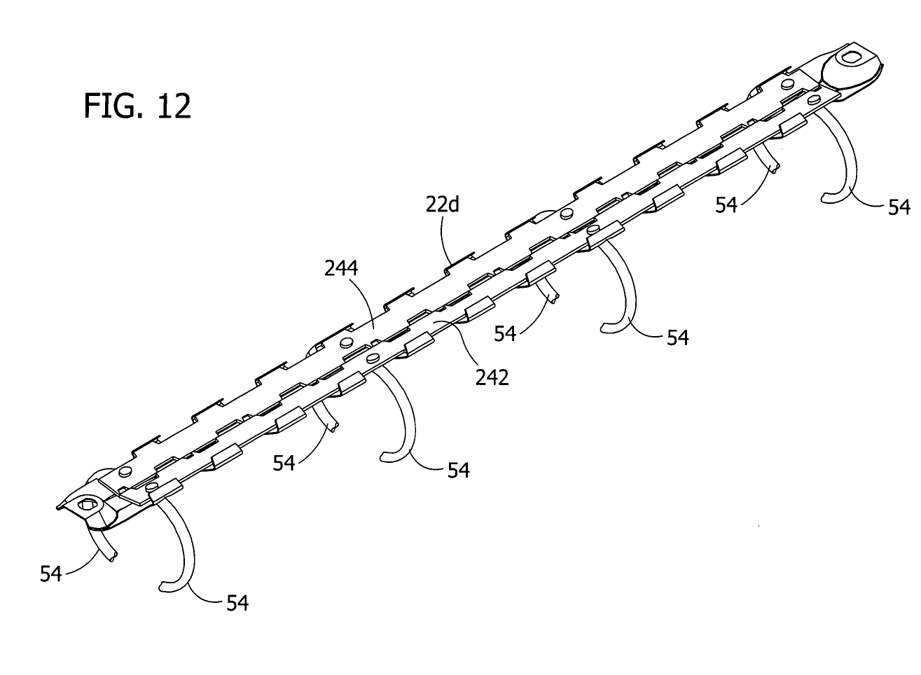

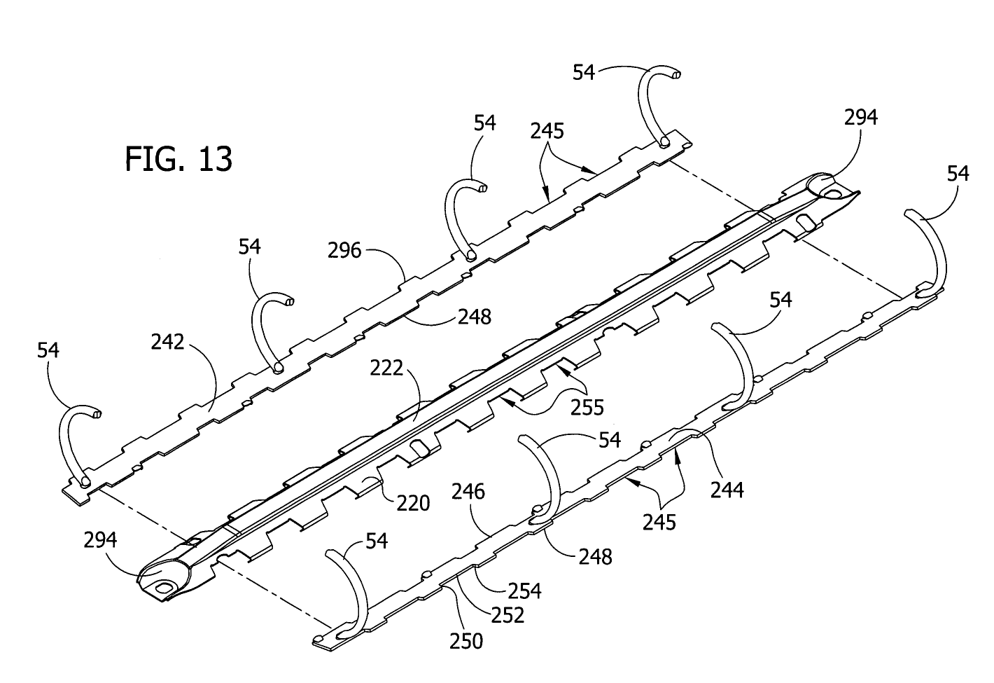

A third embodiment of the present invention is illustrated in FIGS. 9-13. In this embodiment a channel 222 is formed in housing 220 and has a center section 284 of constant box-shaped cross-section which extends for a substantial portion of the length of housing 220. However, the end sections 290 and 292 remain of substantially constant width of the same width as center section 284, but taper downward toward the surface of the main body of housing 220 and merge into a cup-shaped portion 294 formed beyond each end of housing 220. Each cup-shaped portion has an opening 224 formed therein for receiving mounting posts, such as 26a and 26b. The longitudinal edges 232 and 234 of housing 220 are provided with trapezoidal cutouts 235 formed by side margins 236, 238 and 240. Likewise, the hinge plates 242 and 244 (see FIG. 13) are provided with trapezoidal cutouts 245 formed along their longitudinal edges 246 and 248 by side margins 250, 252 and 254.

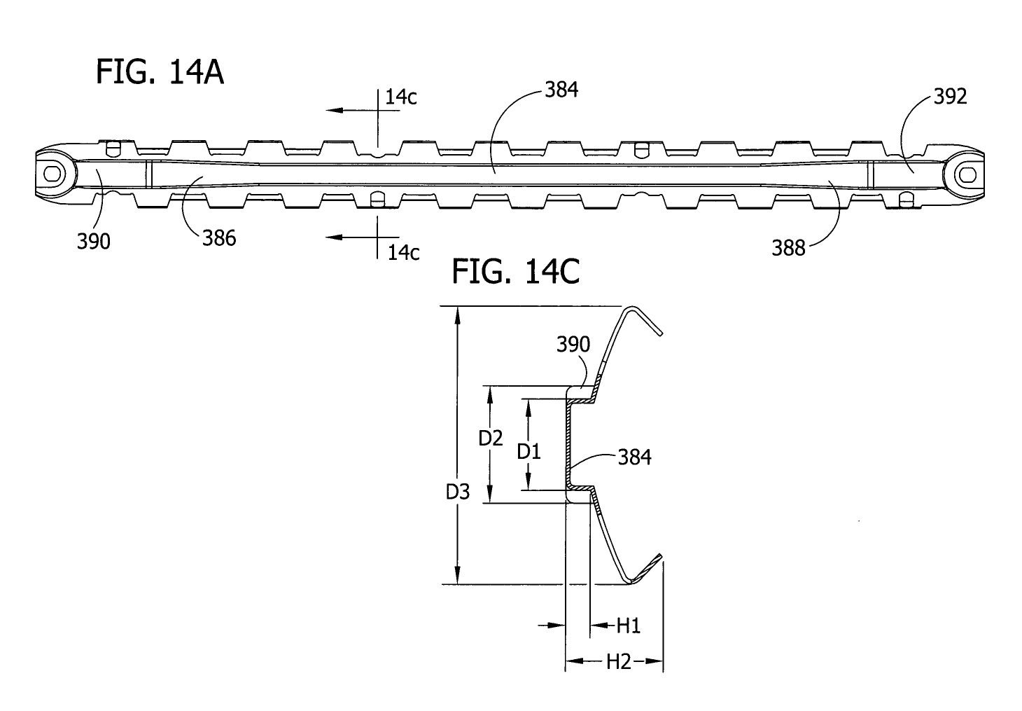

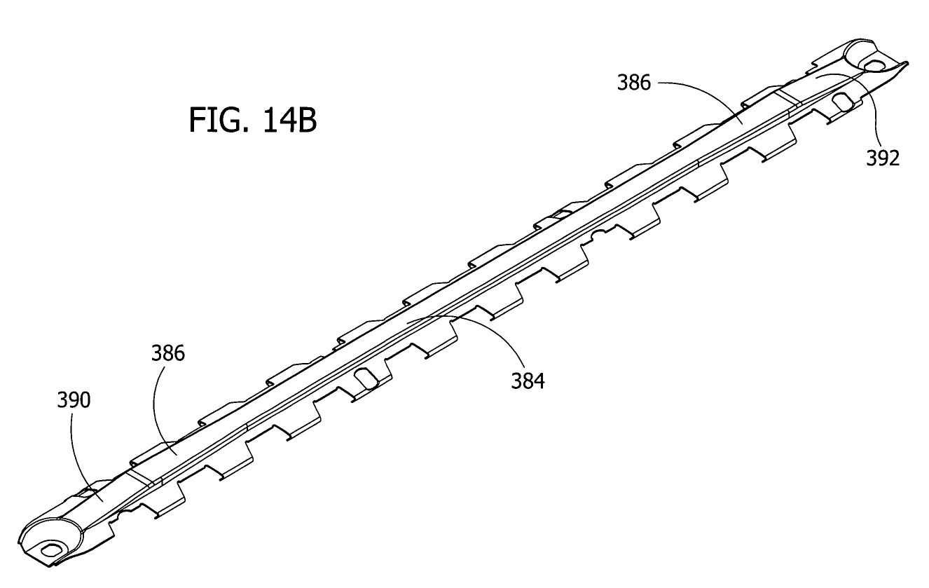

A fourth embodiment of the present invention is illustrated in FIGS. 14A-14C. This embodiment is similar to the third embodiment, except rather than the center section 384 being of constant cross-section along its length, there is a transition section 386 and 388 at each end which has a reducing lateral width while keeping a constant height. The transition sections 386 and 388 join end sections 390 and 392 which are formed like end sections 290 and 292 of the previous embodiment. Otherwise, the fourth embodiment is formed the same as the third embodiment. In this embodiment, the width D1 of section 384 is approximately one-third the width D3 of housing 220, the width D2 of end sections 290 and 292 are approximately forty percent of the width D3 of housing 220 and the height H1 is approximately one-quarter the height H2 of housing 220. The third embodiment is similarly proportioned.

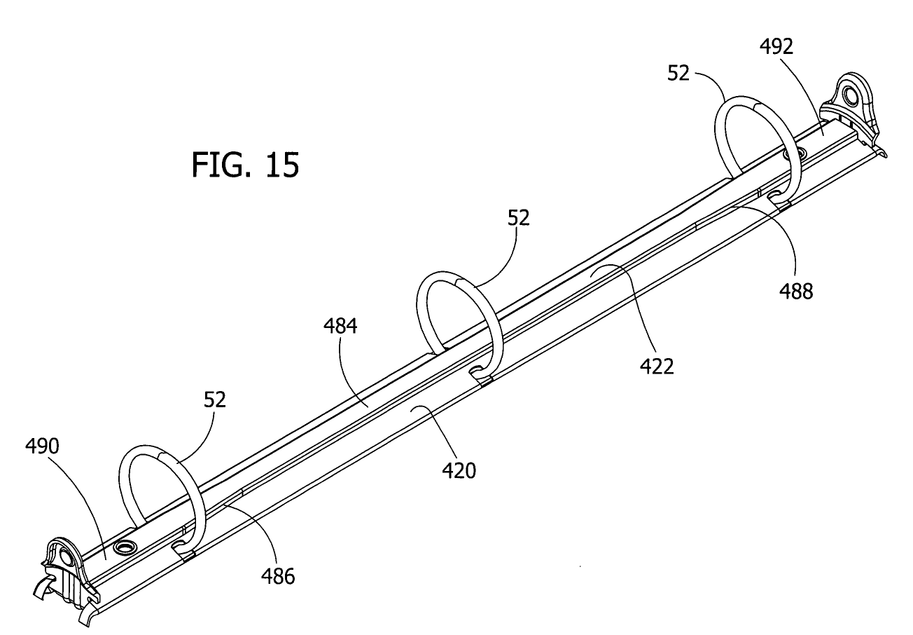

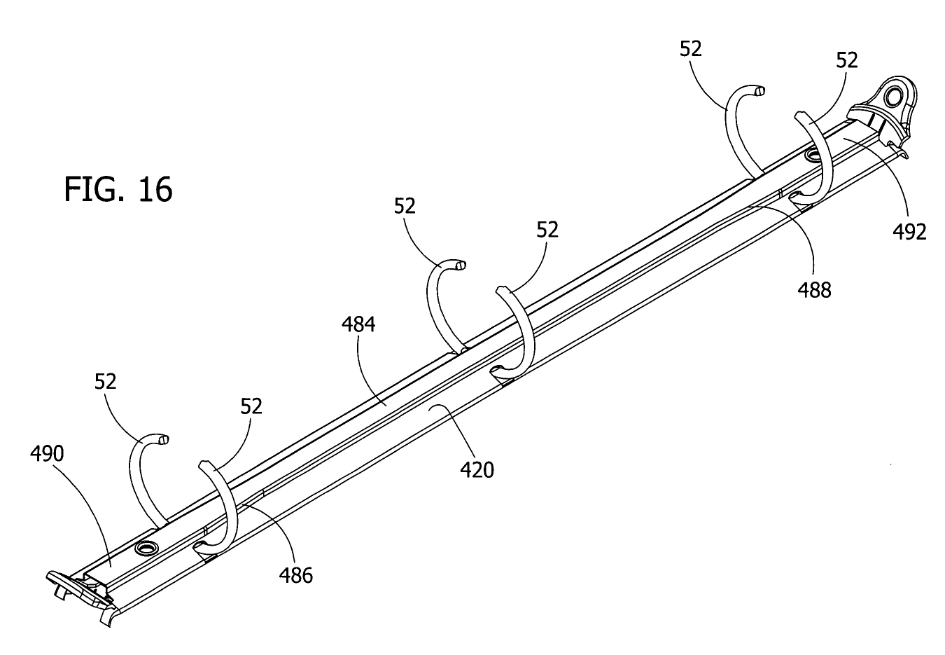

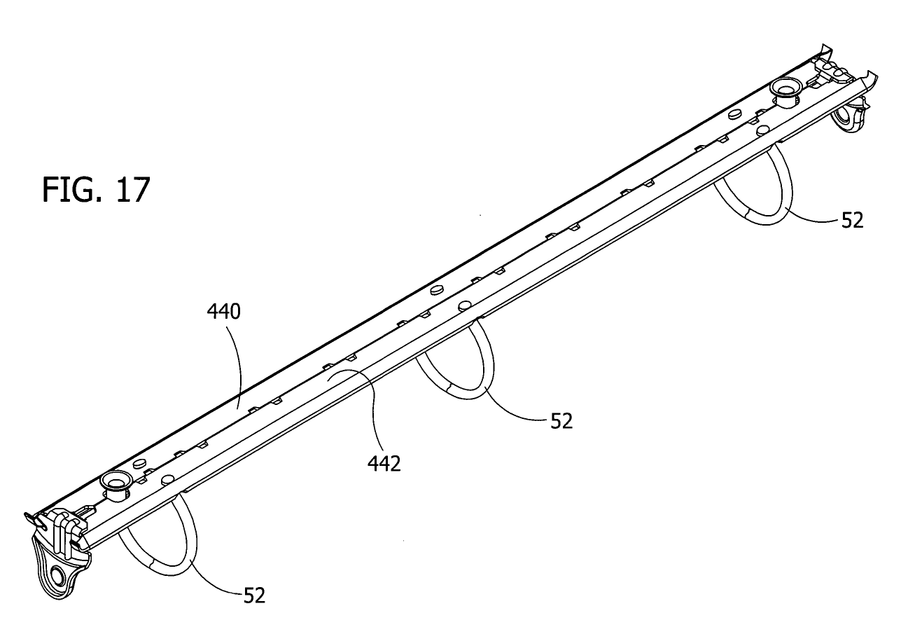

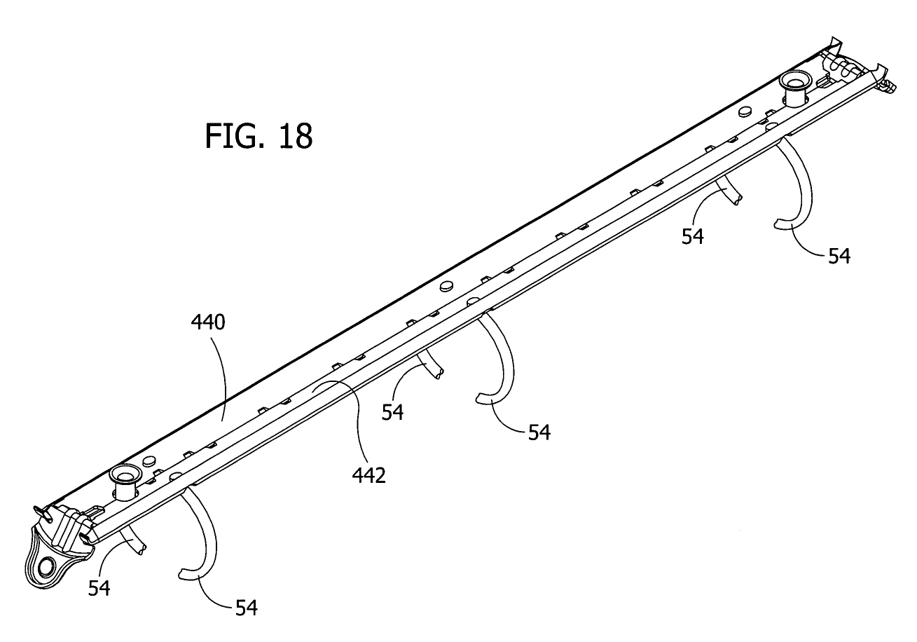

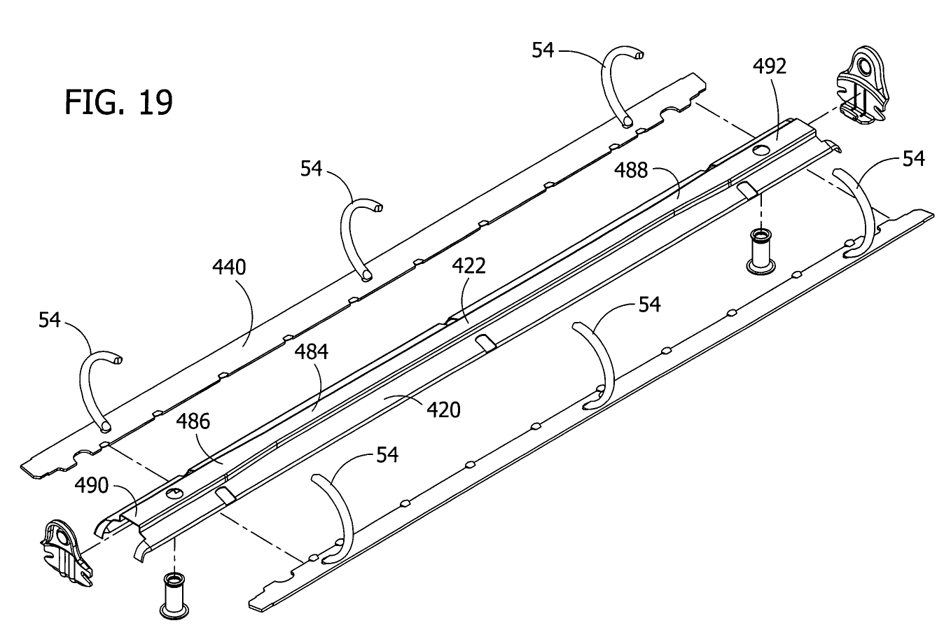

A fifth embodiment is illustrated in FIGS. 15-19. In this embodiment the channel 422 construction is similar to that of the first embodiment in that the channel central section 484 has a constant box-shaped cross-section which extends for approximately three-quarters of the length of housing 420 although the length of this central section can vary as desired for stiffening the housing 420 which is the purpose of this cross-sectional shape. At transitional sections 486 and 488 the channel has a constantly laterally expanding cross-section while keeping the same height, each transitional section joining an outer constant box-shaped cross-section end 490 and 492, respectively. The central section 484, transitional sections 486 and 488 and ends 490 and 492 can be varied in length and cross-section in order to obtain the desired stiffening of the housing 420, as desired. In this embodiment, the housing 420 is not provided with cutouts, as in some previously described embodiments, nor are the hinge plates 440 and 442 provided with cutouts. The proportions of the channel 422 and housing 420 are similar to the fourth embodiment.

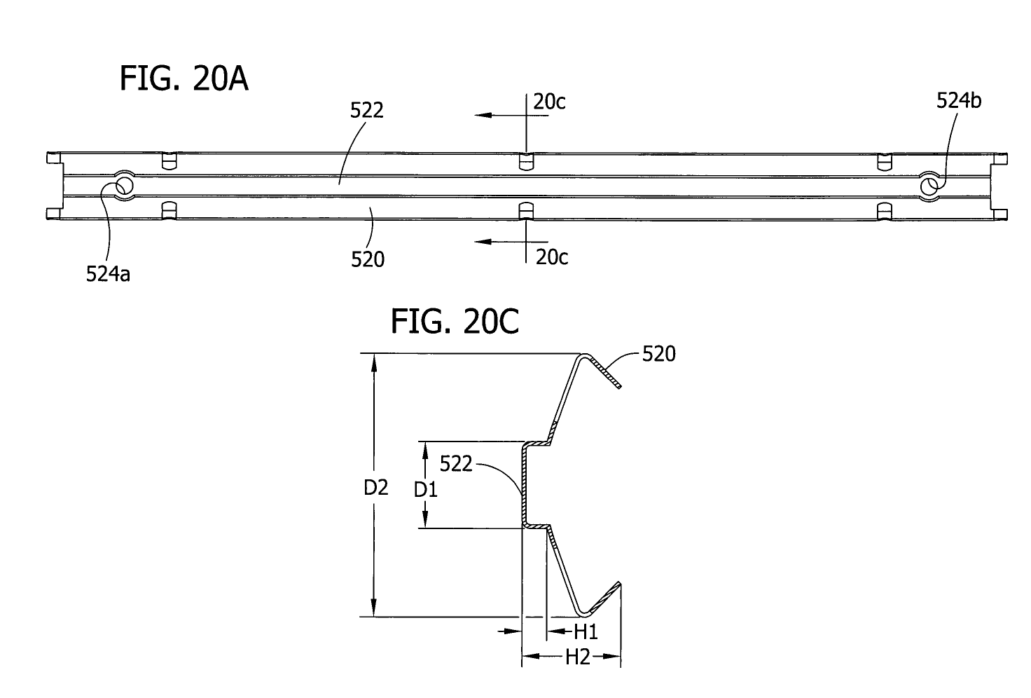

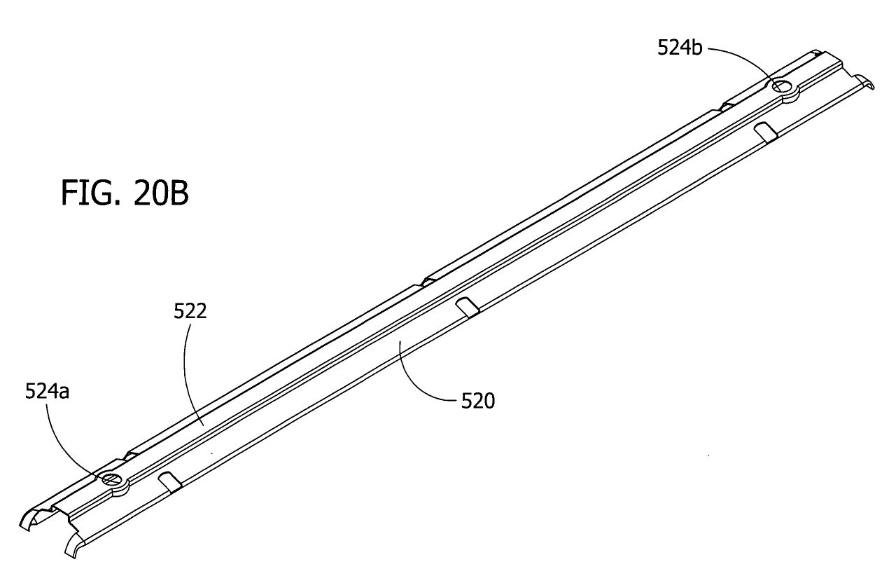

A sixth embodiment is illustrated in FIGS. 20A-20C. In this embodiment the housing 520 has a channel 522 which is similar to that of the second embodiment where its cross-section is essentially constant except in the area of the openings 524a and 524b for receiving the mounting posts (not shown) and where it is expanded in conformity with the openings. In this embodiment, the housing 520 does not have trapezoidal cutouts formed in its longitudinal edges. As shown in FIG. 20C, the width D1 of channel 522 is approximately one-third the width D2 of housing 520 and the height H1 is approximately one-quarter the height H2 of housing 520.

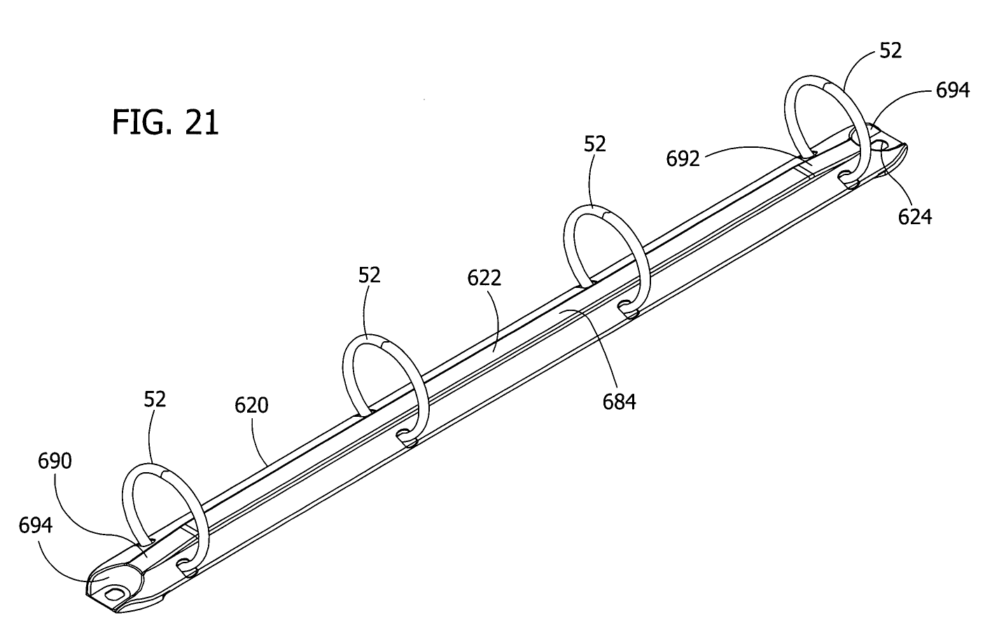

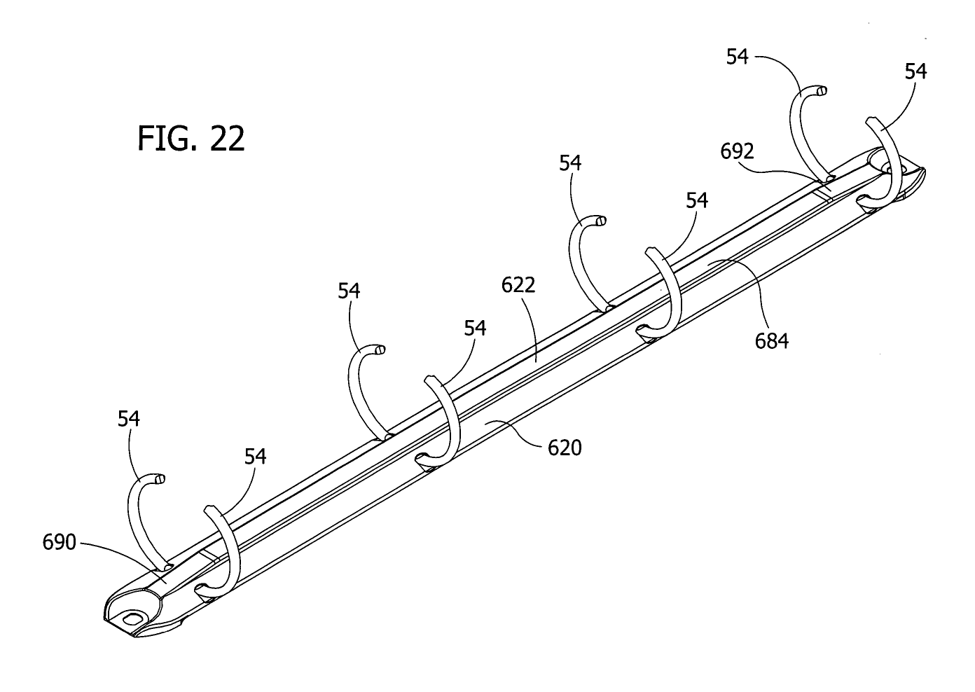

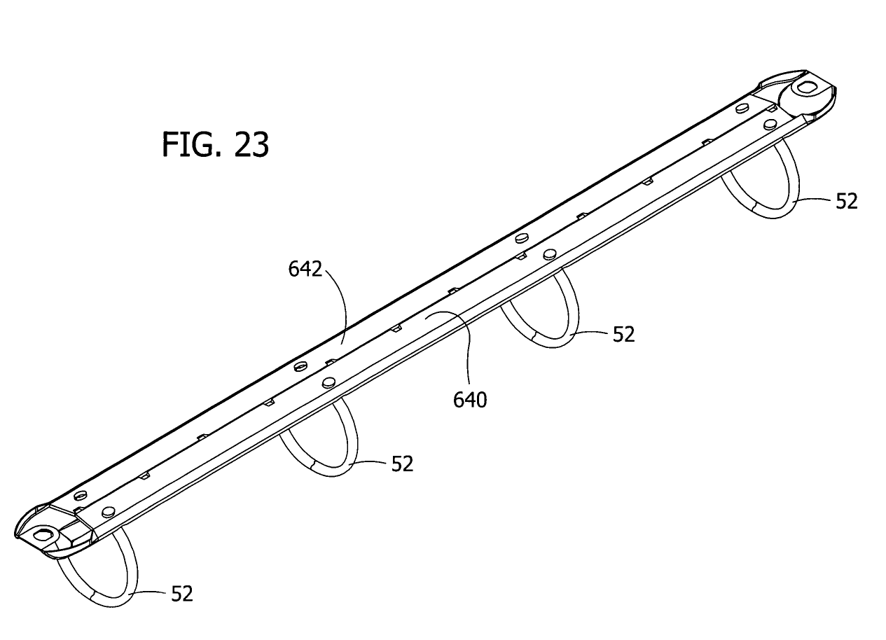

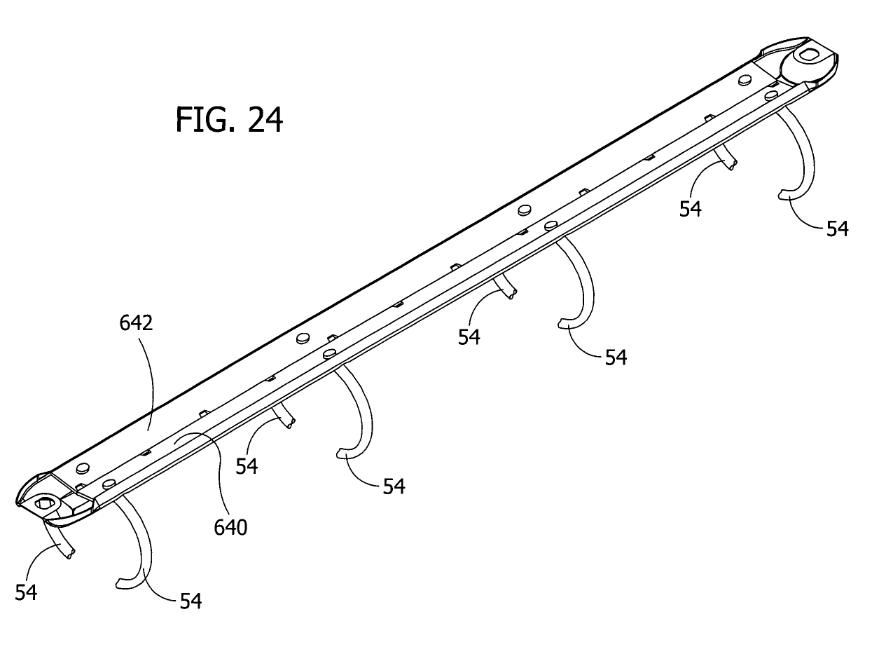

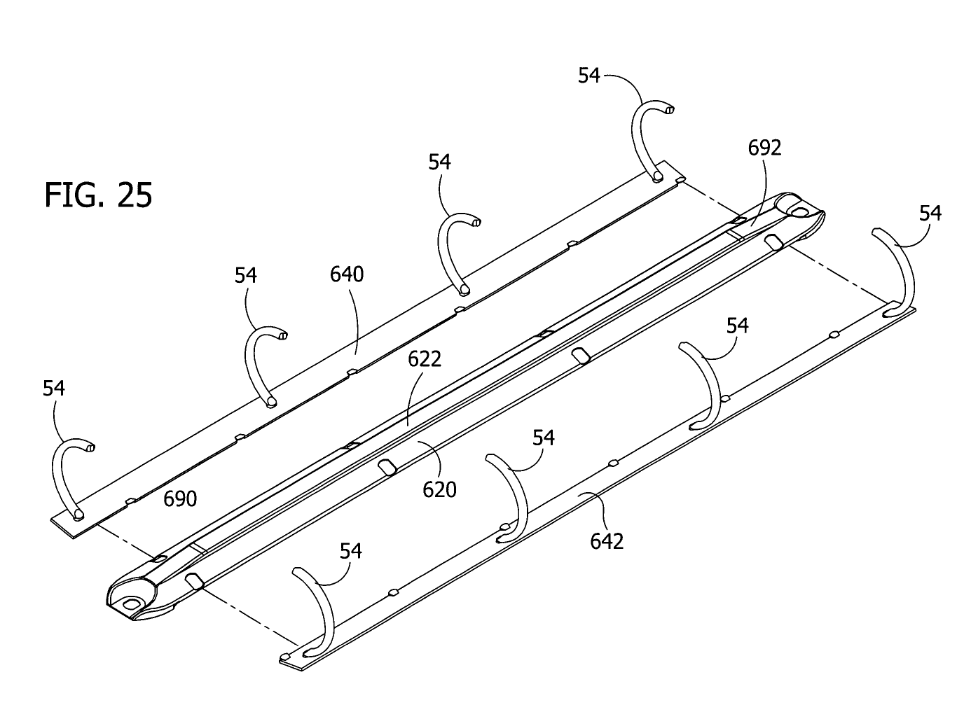

A seventh embodiment is illustrated in FIGS. 21-25. In this embodiment a channel 622 is formed in housing 620 and has a center section 684 of constant box-shaped cross-section which extends for a substantial portion of the length of housing 620. However, the end sections 690 and 692 remain of substantially constant width of the same width as center section 684, but taper downward toward the surface of the main body of housing 620 and merge into a cup-shaped portion 694 formed at each end of housing 620. Each cup-shaped portion has an opening 624 formed therein for receiving mounting posts, such as 26a and 26b. In this embodiment, the housing 620 is not provided with cutouts, as in some previously described embodiments, nor are the hinge plates 640 and 642 provided with cutouts. The proportions of housing 620 and channel 622 are the same as the forth embodiment illustrated in FIGS. 14A-14C.

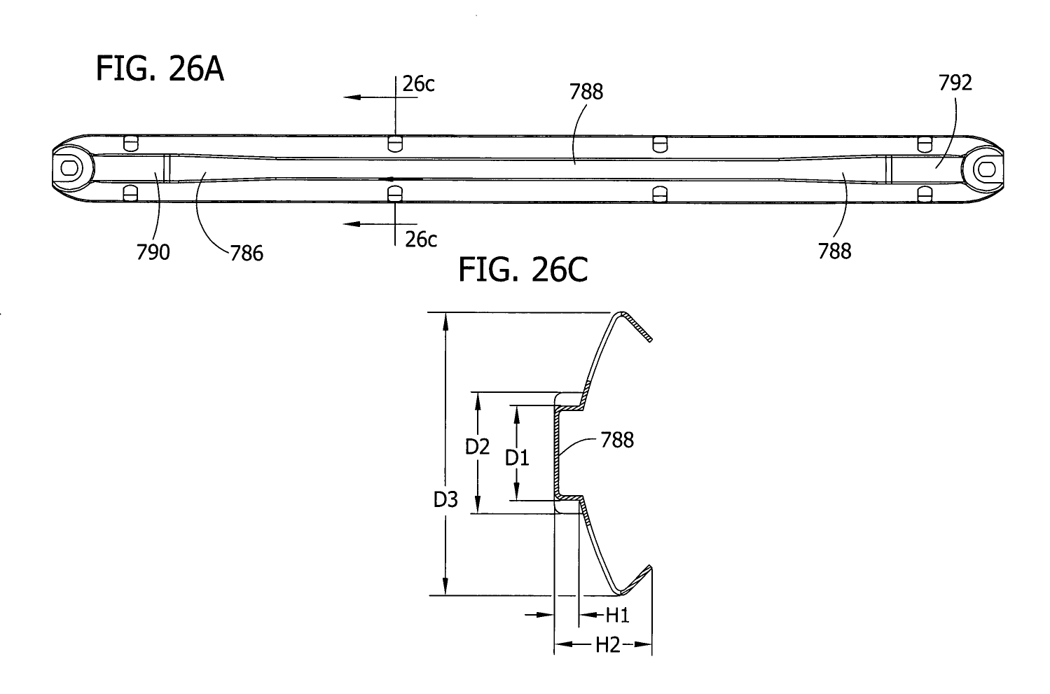

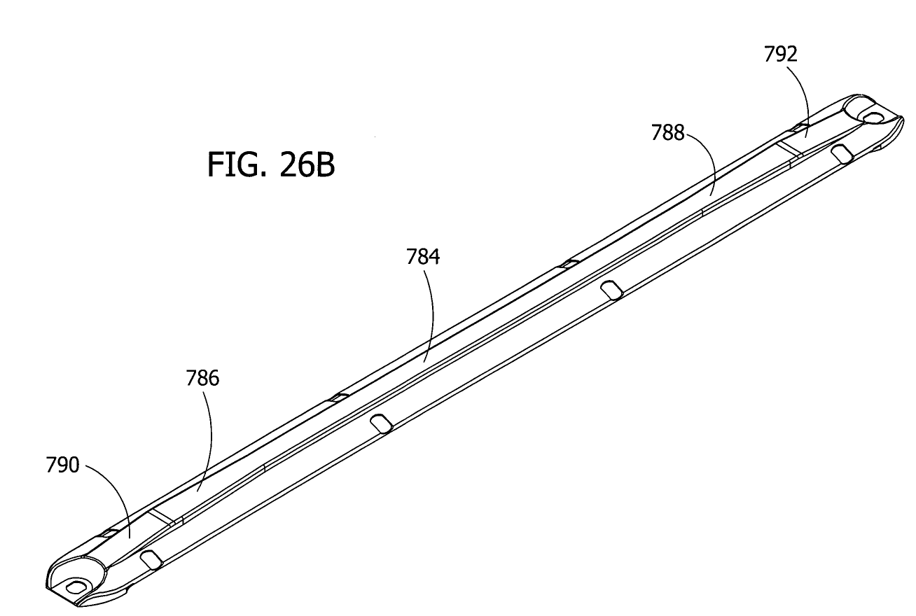

An eighth embodiment is shown in FIGS. 26A-26C. This embodiment is similar to the seventh embodiment, except rather than the center section 784 being of constant cross-section along its length, there is a transition section 786 and 788 at each end which has a reducing lateral width while keeping a constant height. The transition sections 786 and 788 join end sections 790 and 792 which are formed like end sections 690 and 692 of the previous embodiment. Otherwise, the eighth embodiment is formed the same as the seventh embodiment.

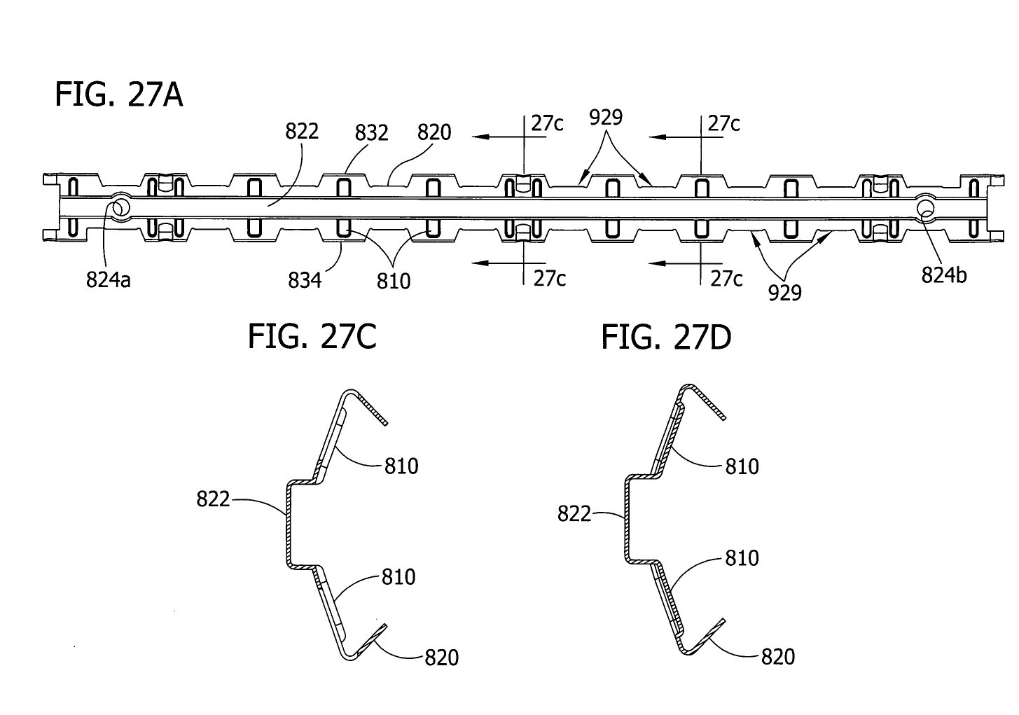

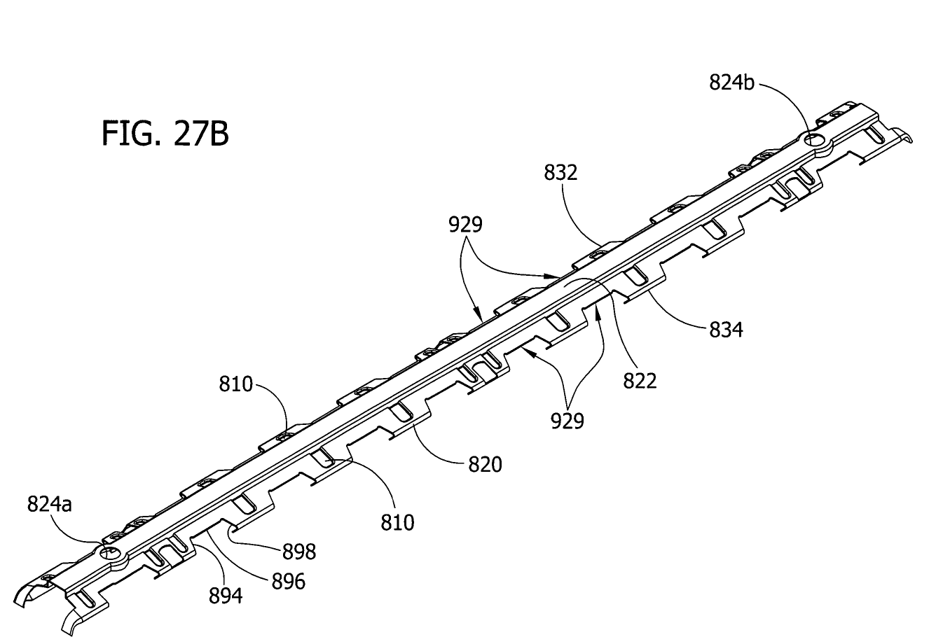

A ninth embodiment of a housing 820 is shown in FIGS. 27A-27D and is similar to the housing 120 shown in FIGS. 8A-8C. In this embodiment the cross-section of channel 822 is essentially constant except in the area of the openings 824a and 824b for receiving the mounting posts (not shown) where it is expanded in conformity with the openings. In this embodiment, the housing 820 has trapezoidal cutouts 829 formed in its longitudinal edges 832 and 834 by side margins 894, 896 and 898. In this embodiment stiffening depressions 810 are provided along the housing transverse to the longitudinal extent of the housing and at multiple locations.

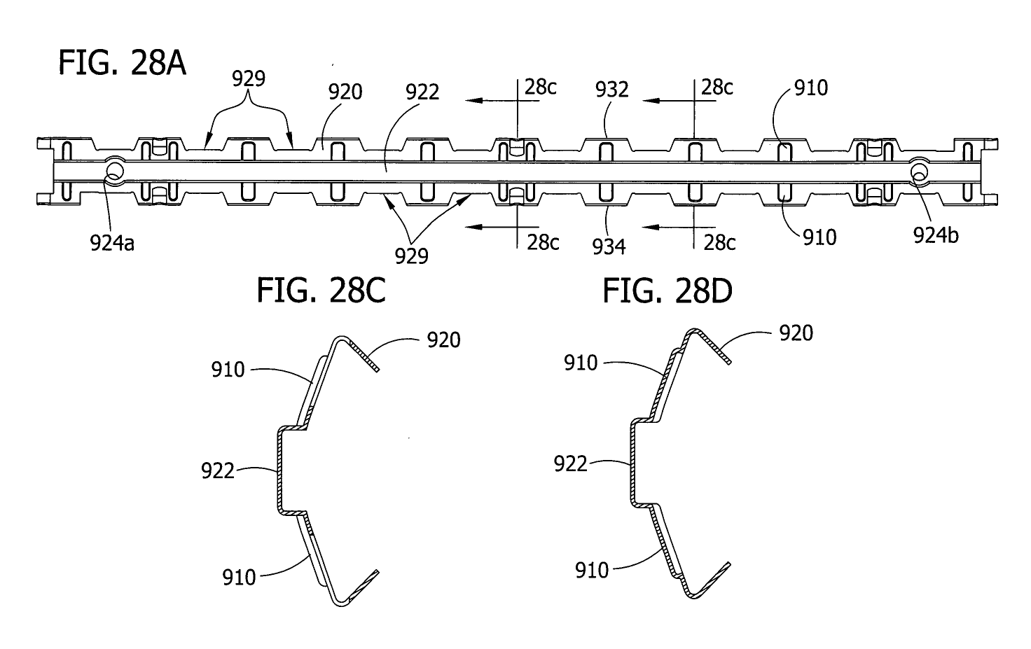

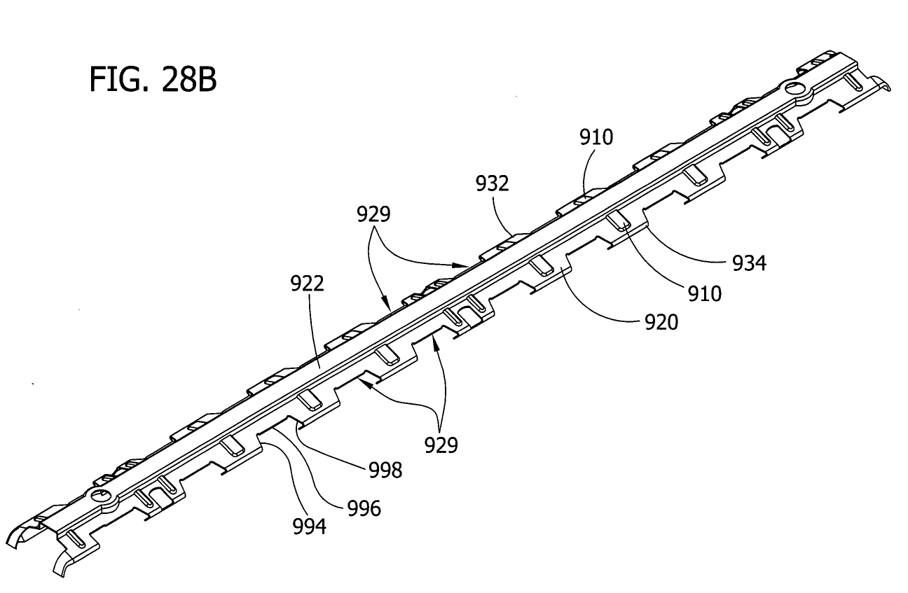

A tenth embodiment of a housing 920 is shown in FIGS. 28A-28D and is similar to the housing 820 shown in FIGS. 27A-27C. In this embodiment the cross-section of channel 922 is essentially constant except in the area of the openings 924a and 924b for receiving the mounting posts (not shown) where it is expanded in conformity with the openings. In this embodiment, the housing 920 has trapezoidal cutouts 929 formed in its longitudinal edges 932 and 934 by side margins 994, 996 and 998. In this embodiment stiffening ridges 910 which are raised on the surface of housing 920, rather than forming depressions as in the previous embodiment, are provided along the housing transverse to the longitudinal extent of the housing and at multiple locations.

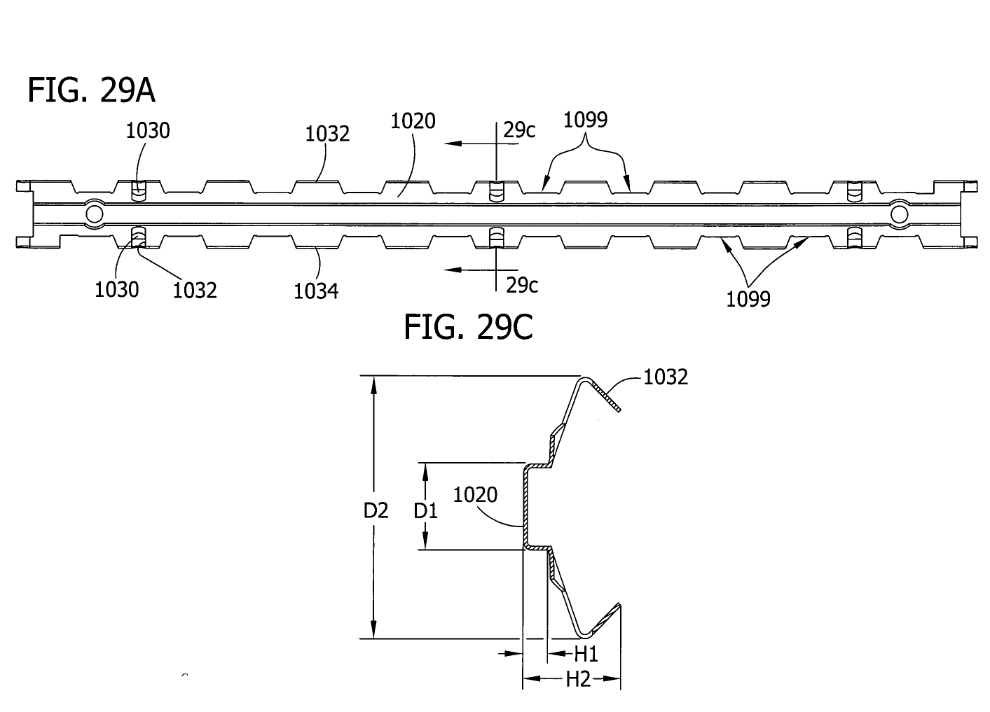

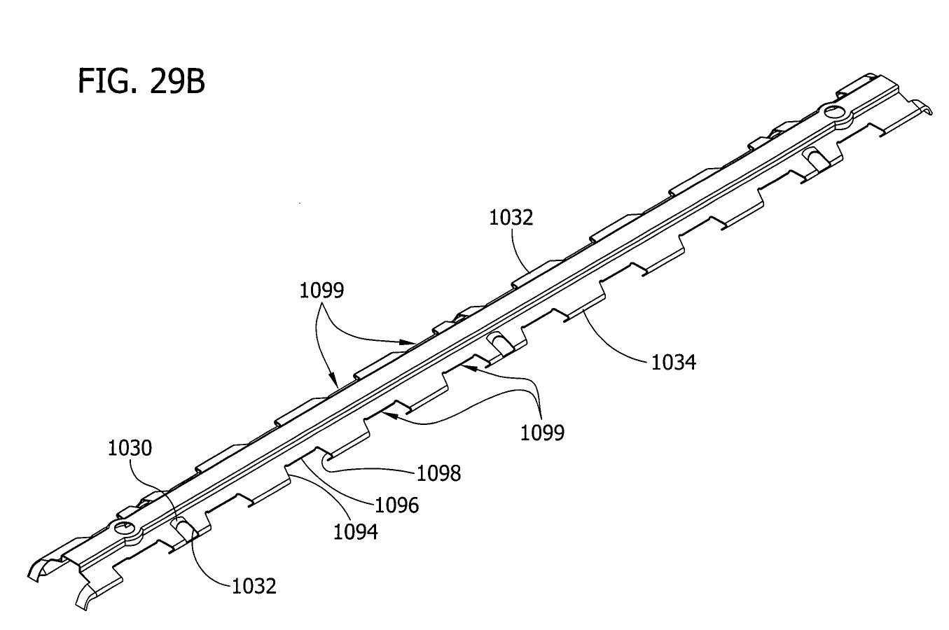

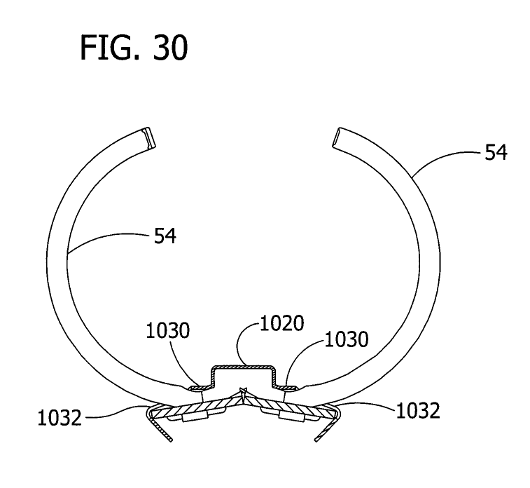

An eleventh embodiment is illustrated in FIGS. 29A-30 which is similar to the ninth and tenth embodiments except there are no stiffening ridges in the housing 1020 between the cutouts 1099 formed by margins 1094, 1096 and 1098 in longitudinal edges 1032 and 1034. In addition, there are small ridges 1030 formed at the top of openings 1032, which receive the ring members 54, in order to provide stiffening in this region. The proportions of the channel to the housing are the same as those in the sixth embodiment illustrated in FIGS. 20a-20C.

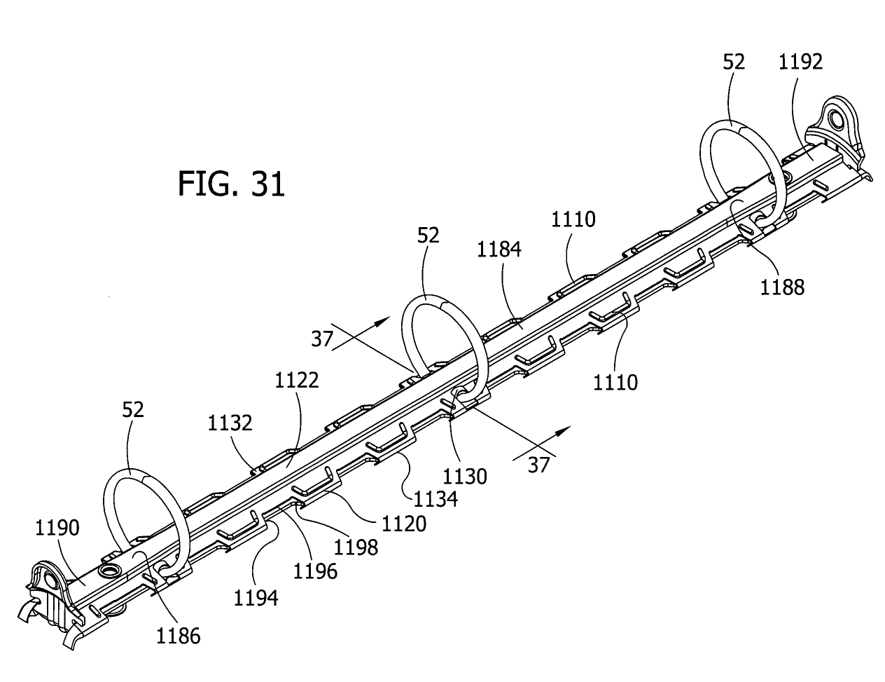

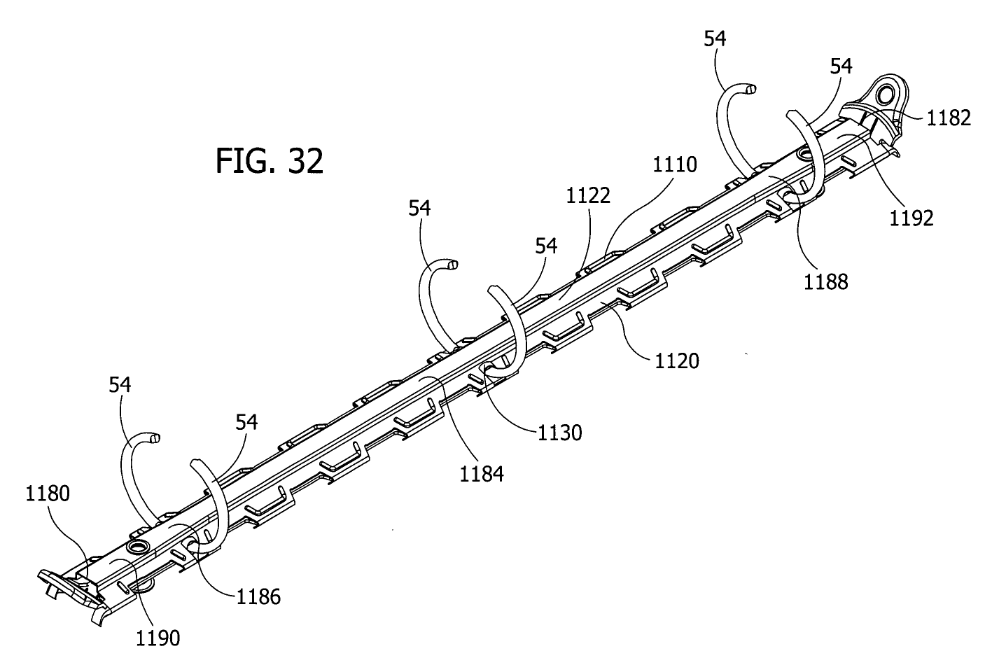

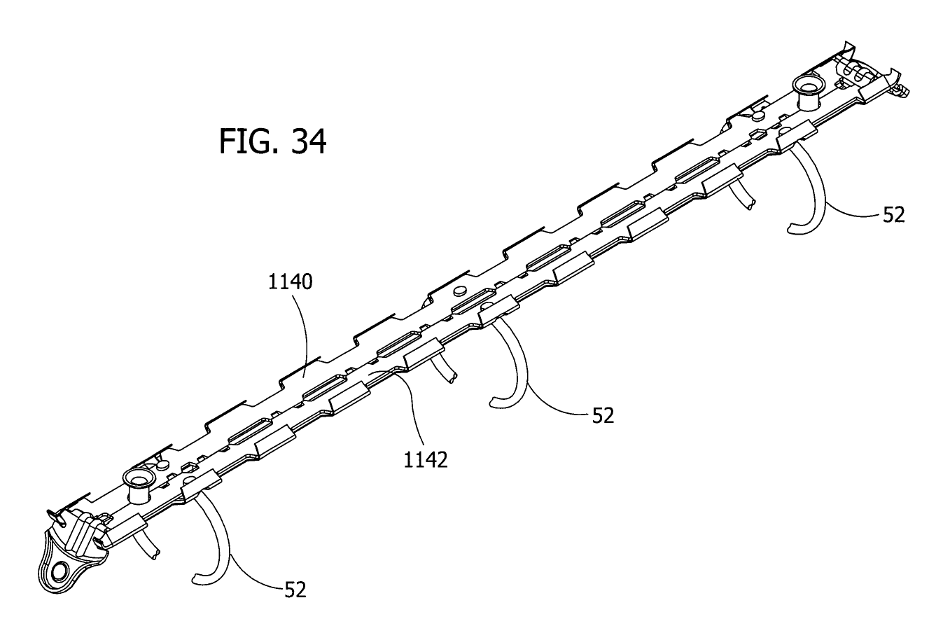

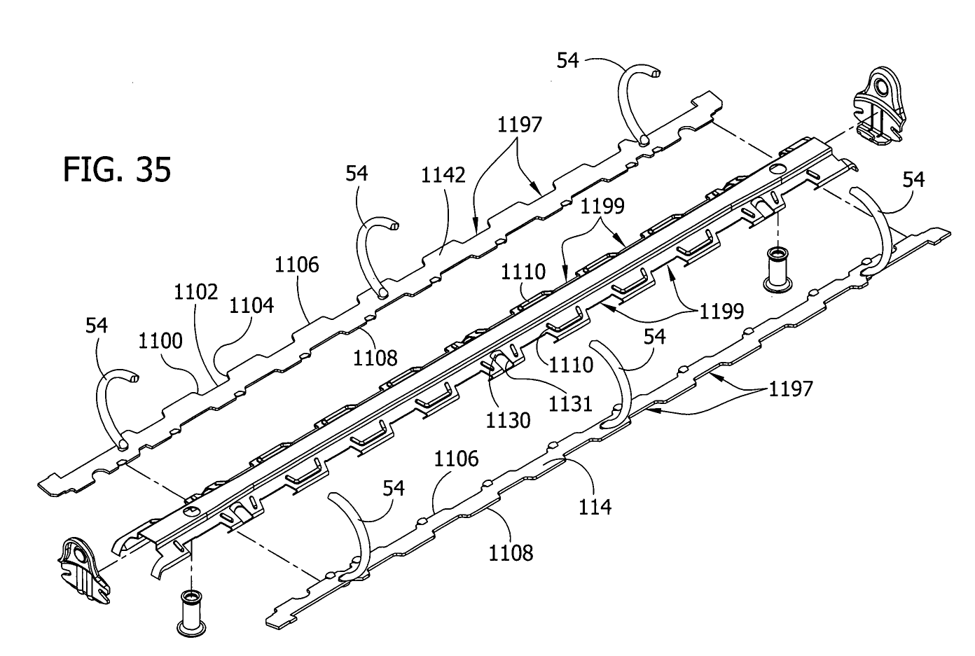

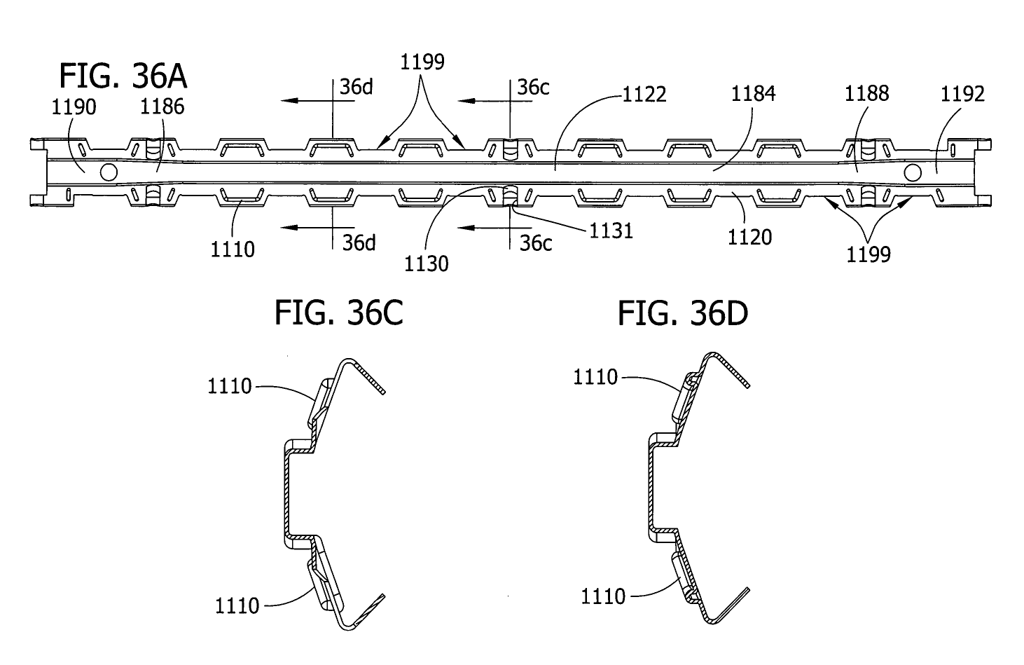

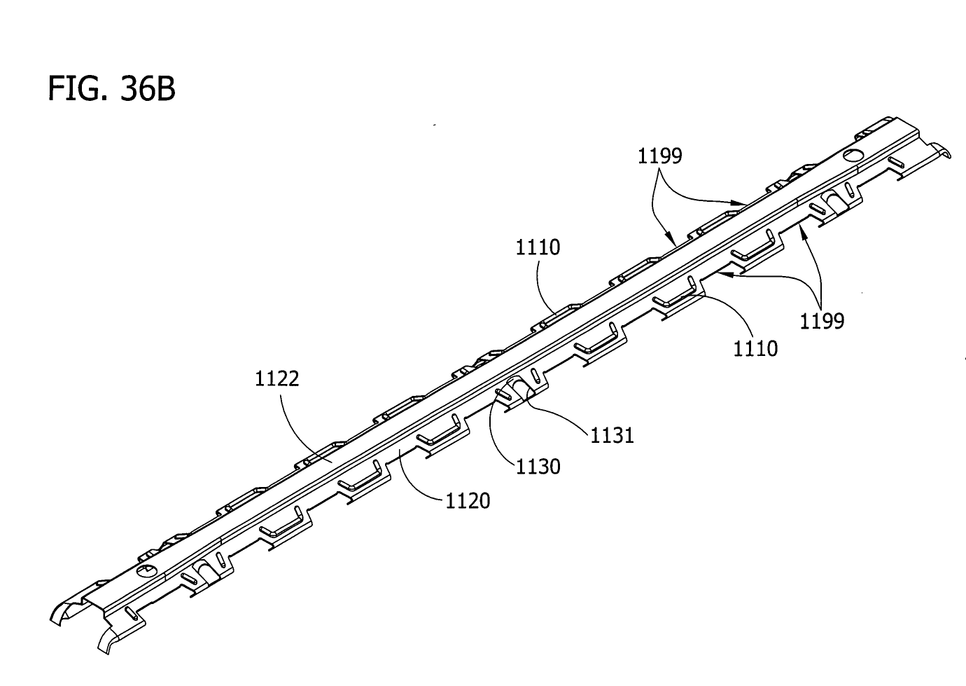

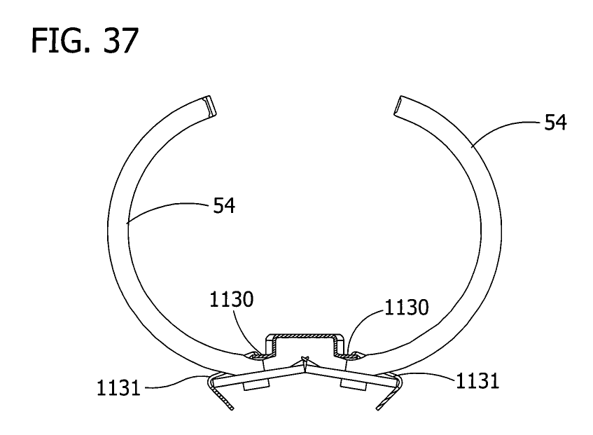

A twelfth embodiment is illustrated in FIGS. 31-37. In this embodiment, housing 1120 has a channel 1122 which has a varying cross-section from end 1180 to end 1182. The central section 1184 of channel 1122 has a constant box-shaped cross-section which extends for approximately three-quarters of the length of housing 1120 although the length of this central section can vary as desired for stiffening the housing 1120 which is the purpose of this cross-sectional shape. At transitional sections 1186 and 1188 the channel has a constantly laterally expanding cross-section while keeping the same height, each transitional section joining an outer constant box-shaped cross-section end 1190 and 1192, respectively. The central section 1184, transitional sections 1186 and 1188 and ends 1190 and 1192 can be varied in length and cross-section in order to obtain the desired stiffening of the housing 1120, as desired.

In addition to the stiffening structure described above, a further aspect of this embodiment is the removal of substantial amounts of material from the housing by a series of generally trapezoidal cutouts 1199 formed by side margins 1194, 1196 and 1198 through the longitudinal edges 1132 and 1134 housing 1120. These cuts reduce the structural stiffness of the housing 1120, but this is compensated for by the cross-sectional structure of channel 1122 described above so that an adequate structural stiffness can be provided in housing 1120 with reduced material usage from prior art devices. In addition, generally semi-cylindrical cross-section ridges 1110 are formed in the housing 1120 in a shape which follows the pattern formed by the cutouts 1199 in the housing to add additional stiffening to the housing 1120 as a result of the removal of material to form the cutouts. In addition, there are small ridges 1130 formed at the top of openings 1131 which receive the ring members 54 in order to provide stiffening in this region.

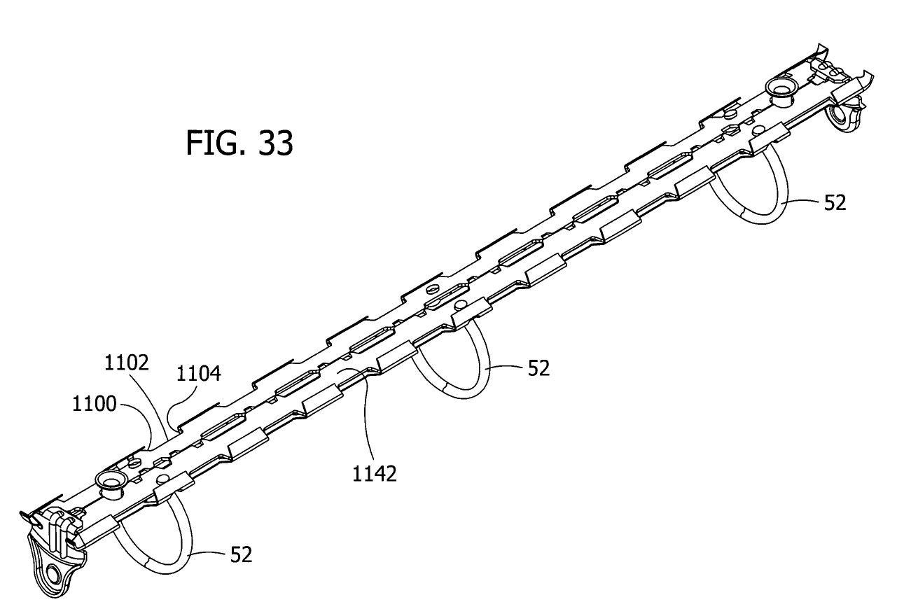

Also in this embodiment, hinge plates 1140 and 1142 are provided with generally trapezoidal cutouts 1197 formed by side margins 1100, 1102 and 1104 in longitudinal edges 1106 and 1108 in each hinge plate. These trapezoidal cutouts 1197 are preferably aligned with corresponding trapezoidal cutouts 1199 in the housing 1120 when the hinge plates are assembled in the housing, as shown, for example, in FIGS. 31 and 33.

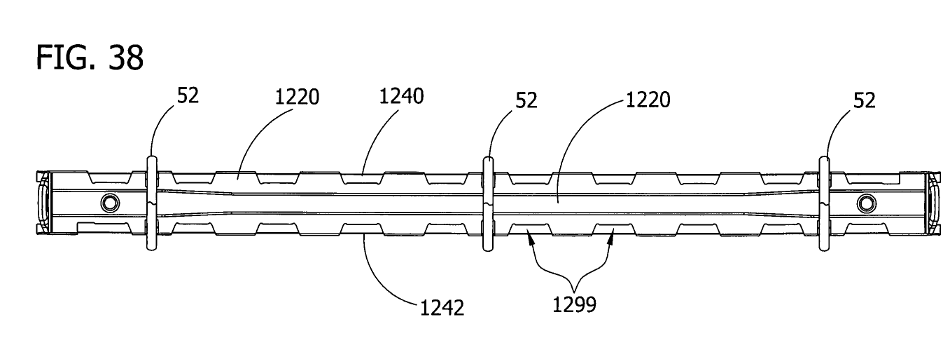

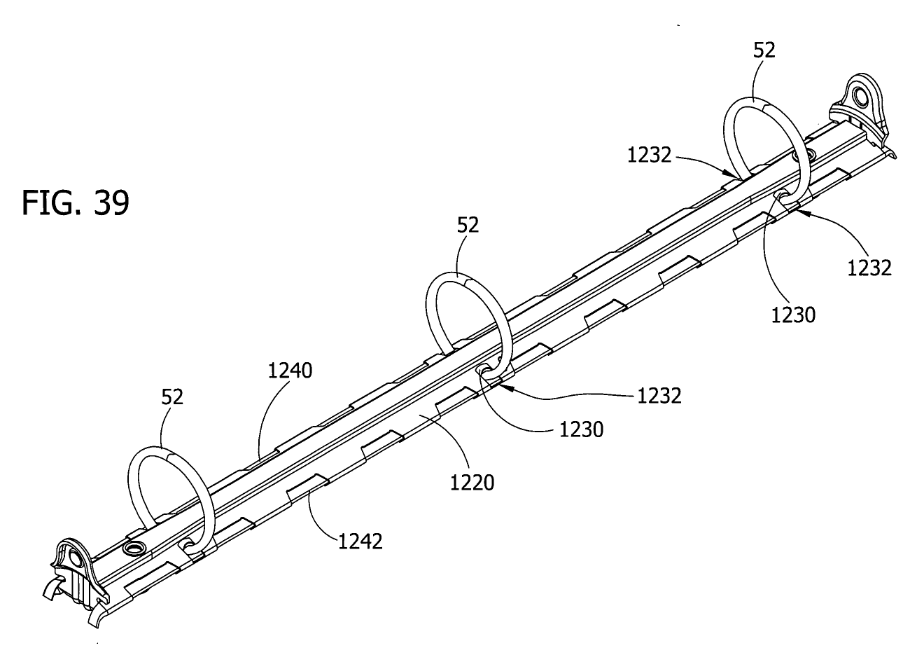

A thirteenth embodiment is illustrated in FIGS. 38 and 39 which is similar to the embodiment shown in FIGS. 31-37 except the ridges 1110 formed in housing 1120 have been removed. In this embodiment, housing 1220 depends on channel 1222 for stiffening. The trapezoidal cutouts formed in that embodiment are removed from the hinge plates 1240 and 1242 of the present embodiment so that the straight side edges can be seen through cutouts 1299 formed in the housing 1220. In addition, there are small ridges 1230 formed at the top of openings 1232, which receive the ring members 54, in order to provide stiffening in this region.

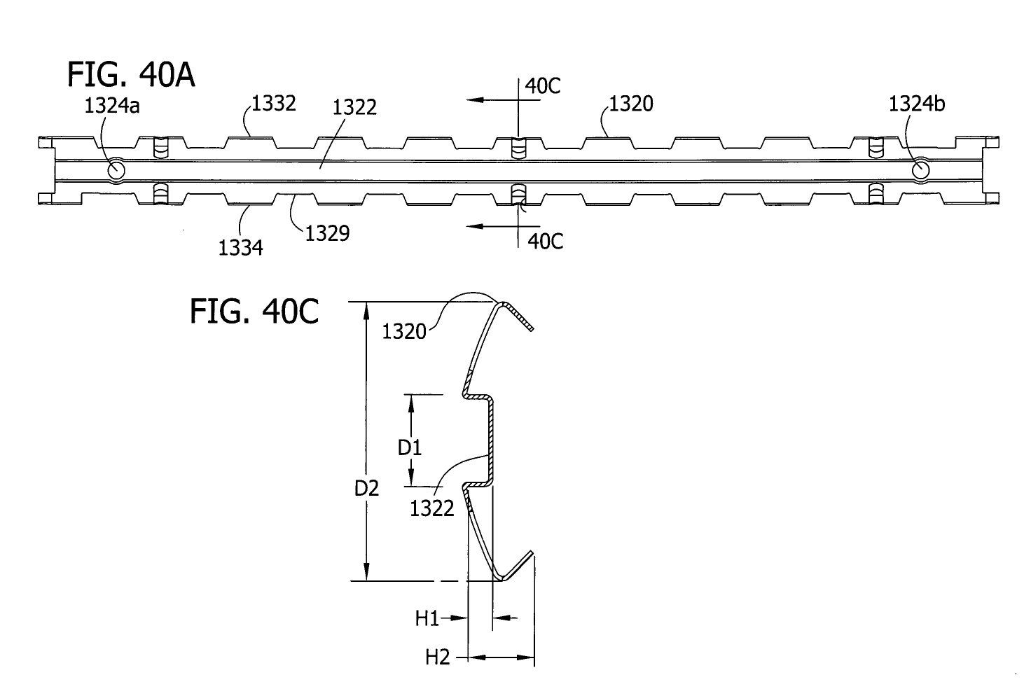

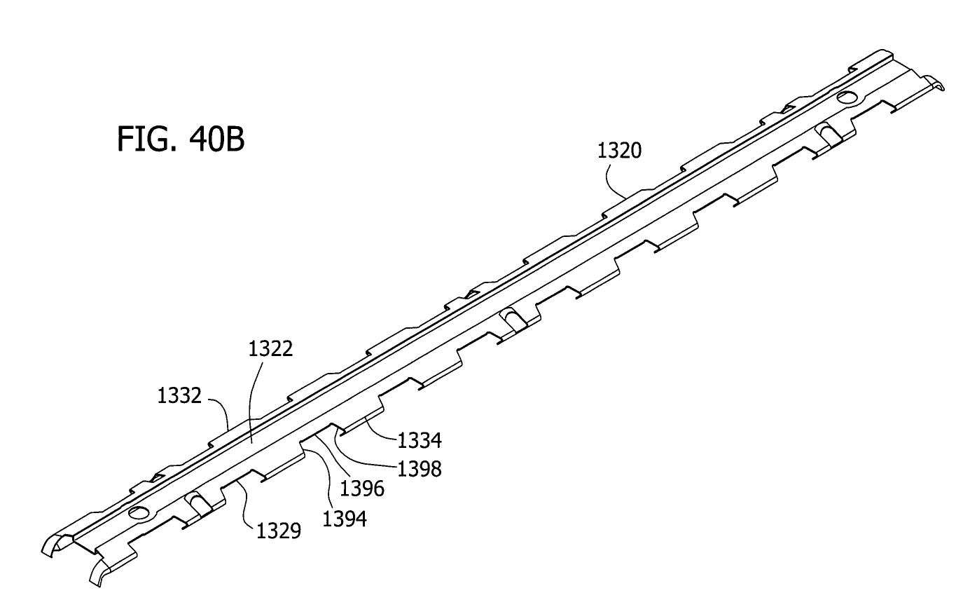

FIGS. 40A-40C show a fourteenth embodiment similar to that illustrated in FIGS. 8A-8C but in which the cross-section of the channel 1322 is inverted so that it extends below the surface of the remainder of the housing and is essentially constant except in the area of the openings 1324a and 1324b for receiving the mounting posts (not shown) where it is expanded in conformity with the openings. In this In this embodiment, the housing 1320 also has trapezoidal cutouts 1329 formed in its longitudinal edges 1332 and 1334 by side margins 1394, 1396 and 1398. The hinge plates (not shown) can be shaped as in the first embodiment. As shown in FIG. 40C, the width D1 of channel 1322 is approximately one-third the width D2 of housing 1320 and the height H1 (or depth in this instance) is approximately one-quarter the height H2 of housing 1320.

Components of ring binder mechanisms of the invention are made of a suitable rigid material, such as a metal (e.g., steel). But mechanisms having components made of a nonmetallic material, specifically including a plastic, do not depart from the scope of this invention.

When introducing elements of the invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations of these terms is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring mechanism for retaining loose-leaf pages, the mechanism comprising:
a housing having a longitudinal axis, a central top portion and an open bottom generally opposed to the central top portion, the central top portion having a longitudinally extending channel therein along the entire length of the housing and having opposed ends and a middle portion;
hinge plates supported by the housing for pivoting movement relative to the housing;
rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings.

2. A ring mechanism as claimed in claim 1 wherein the channel has different cross-sections along its length.

3. A ring mechanism as claimed in claim 2 wherein the cross-sections differ in a lateral direction.

4. A ring mechanism as claimed in claim 2 wherein the cross-sections differ in a vertical direction.

5. A ring mechanism as claimed in claim 1 wherein the channel has substantially the same cross-section along its length.

6. A ring mechanism as claimed in claim 1 wherein the housing has cutouts along at least one of its longitudinal edge margins.

7. A ring mechanism as claimed in claim 6 wherein the cutouts do not receive a ring member.

8. A ring mechanism as claimed in claim 6 wherein the hinge plates each have cutouts along at least one of their longitudinal edge margins.

9. A ring mechanism as claimed in claim 8 wherein at least some of the cutouts on each hinge plate are located along a longitudinal outer edge margin of the hinge plate corresponding to the cutouts in the housing.

10. A ring mechanism as claimed in claim 1 wherein the channel projects upwardly from the remainder of the housing.

11. A ring mechanism as claimed in claim 1 wherein the channel extends downwardly into the housing.

12. A ring mechanism for retaining loose-leaf pages, the mechanism comprising:
a housing having a longitudinal axis, a central top portion and an open bottom generally opposed to the central top portion, at least one rib on the housing disposed generally transverse to the longitudinal axis thereof;
hinge plates supported by the housing for pivoting movement relative to the housing;
rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings.

13. A ring mechanism as claimed in claim 12, including a plurality of the ribs being spaced along the longitudinal axis of the housing.

14. A ring mechanism for retaining loose-leaf pages, the mechanism comprising:
a housing having a longitudinal axis, a central top portion and an open bottom generally opposed to the central top portion;
hinge plates supported by the housing for pivoting movement relative to the housing;
rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings;
the housing also having a plurality of openings defined therein for receiving a corresponding first or second ring member when the ring members are in the closed position, an area of the housing immediately surrounding each opening having a ridge formed therein.

15. A ring mechanism for retaining loose-leaf pages, the mechanism comprising:
a housing having a longitudinal axis, a central top portion, an open bottom generally opposed to the central top portion, and opposed longitudinal edges extending along the length of the housing, the housing having a plurality of separate openings defined therein spaced along the length of the housing and extending into either of the opposed longitudinal edges;
hinge plates supported by the housing for pivoting movement relative to the housing;
rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings.

16. A ring binder mechanism as claimed in claim 15, including the hinge plates having openings defined therein corresponding to and juxtaposed with the openings defined in the housing.
